(19) United States
(12) Patent Application Publication
(10) Pub. No.: US 2013/0193840 A1
(43) Pub. Date: Aug. 1, 2013

(54) COMPOSITION AND LIGHT-EMITTING DEVICE USING THE SAME

(71) Applicant: Sumitomo Chemical Company, Limited, Tokyo (JP)

(72) Inventors: Masayuki SOGA, Nishitokyo-shi (JP); Osamu GOTO, Tsukuba-shi (JP); Kazuei OHUCHI, Tsukuba-shi (JP); Nobuhiko AKINO, Tsukuba-shi (JP); Toshiaki SASADA, Tsukuba-shi (JP); Makoto ANRYU, Setsu-shi (JP)

(73) Assignee: SUMITOMO CHEMICAL COMPANY, LIMITED, Tokyo (JP)

(21) Appl. No.: 13/740,744

(22) Filed: Jan. 14, 2013

Related U.S. Application Data
(63) Continuation-in-part of application No. 13/809,971, filed on Mar. 29, 2013.

(30) Foreign Application Priority Data
Jul. 16, 2010 (JP) 2010-161682

(51) Int. Cl. C09K 11/06; H05B 33/14

(52) U.S. Cl. CPC C09K 11/06; H05B 33/14
USPC 313/504; 252/301.16; 252/301.35

(57) ABSTRACT

A composition including: a phosphorescent light-emitting compound (B) that has a light-emitting spectrum peak smaller than 480 nm, a phosphorescent light-emitting compound (G) that has a light-emitting spectrum peak at 480 nm or larger and smaller than 580 nm, and a phosphorescent light-emitting compound (R) that has a light-emitting spectrum peak at 580 nm or larger and smaller than 680 nm, in which the phosphorescent light-emitting compound (R) is a phosphorescent light-emitting compound having a dendrimer structure. A liquid composition including the composition and a solvent, a film containing the composition, and a light-emitting device having an anode, a cathode, and an organic layer containing the composition provided between the anode and the cathode.

### CROSS-REFERENCE TO RELATED APPLICATIONS

This application is a continuation-in-part of U.S. patent application which is a national phase filing of PCT/JP2010/065989 filed on Jul. 13, 2011, which claims the benefit of priority from Japanese Patent Application No. 2010-161638 filed on Jul. 16, 2010, and claims the benefit of priority from this application. The entire contents of these application are incorporated herein by reference.

### TECHNICAL FIELD

The present invention relates to a composition and a light-emitting device using the same.

### BACKGROUND

A light-emitting device such as an organic electroluminescent device (organic EL device) is suitable for an application such as a display because of characteristics such as low voltage driving and high brightness thereof, and has attracted attention in recent years. As a light-emitting material used for a light-emitting layer of a light-emitting device, for example, a white color light-emitting composition containing a blue color phosphorescent light-emitting compound, a green color phosphorescent light-emitting compound, and a red color phosphorescent light-emitting compound represented by formula below is known (for example, Patent Literature 1).

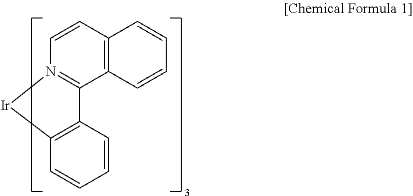

### RELATED ART DOCUMENTS

### Patent Literature

Patent Literature 1: Japanese Patent Application Laid-open No. 2004-14155

### SUMMARY OF THE INVENTION

### Problem to be Solved by the Invention

However, the white color light-emitting device manufactured using the above composition has external quantum efficiency that is not necessarily satisfactory.

Thus, it is an object of the present invention to provide a composition useful for manufacturing a white color light-emitting device excellent in external quantum efficiency. It is also an object of the present invention to provide a liquid composition, a film, and a light-emitting device containing the composition.

### Means for Solving Problem

The present invention provides the following composition, liquid composition, film, and light-emitting device.

[1] A composition comprising a phosphorescent light-emitting compound (B) that has a light-emitting spectrum peak smaller than 480 nm, a phosphorescent light-emitting compound (G) that has a light-emitting spectrum peak at 480 nm or larger and smaller than 580 nm, and a phosphorescent light-emitting compound (R) that has a light-emitting spectrum peak at 580 nm or larger and smaller than 680 nm, wherein

the phosphorescent light-emitting compound (R) is a phosphorescent light-emitting compound having a dendrimer structure.

[2] The composition according to [1], wherein the phosphorescent light-emitting compound (R) is a metal complex represented by Formula (R-A):

[Chemical Formula 2]

M^{R}(L^{R1})a^{R1}(L^{R2})b^{R1} (R-A)

wherein

M^{R} represents a central metal atom;

L^{R1} represents a ligand that has a substituent having a dendrimer structure, and when L^{R1} is plurally present, L^{R1}s may be the same as or different from each other;

L^{R2} represents a ligand, with the proviso that L^{R2} is different from L^{R1}, and when L^{R2} is plurally present, L^{R2}s may be the same as or different from each other; and
a^{R1} represents an integer of 1 or more and b^{R1} represents an integer of 0 or more, with the proviso that a^{R1}+a^{R1} exists so as to satisfy a valence that the metal atom M^{R} has.
   [3] The composition according to [2], wherein M^{R} is a platinum atom or an iridium atom.
   [4] The composition according to [2] or [3], wherein L^{R1} is a monoanionic didentate ligand represented by Formula (LR):

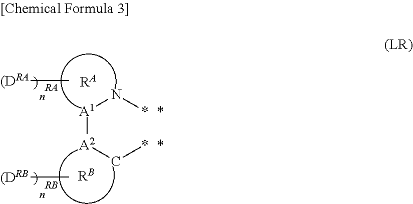

wherein

A¹ and A² each independently represent a carbon atom or a nitrogen atom;

the ring R^{A} represents a 5-membered or 6-membered aromatic heterocyclic ring having one or more nitrogen atom(s);

the ring R^{B} represents a 5-membered or 6-membered aromatic hydrocarbon ring or a 5-membered or 6-membered aromatic heterocyclic ring;

** represents a bond with the central metal atom;

D^{RA} and D^{RB} each independently represent a substituent having a dendrimer structure, and when D^{RA} and D^{RB} are plurally present, D^{RA}s or D^{RB}s are optionally the same as or different from each other; and

n^{RA} and n^{RB} each independently represent an integer of 0 or more, with the proviso that n^{RA}+n^{RB} is 1 or more.

[5] The composition according to [4], wherein the ring R^{A} is a pyridine ring, a quinoline ring, or an isoquinoline ring.
[6] The composition according to [4], wherein the ring R^{B} is a benzene ring.
[7] The composition according to any one of [1] to [6], wherein a ratio of the total weight of the phosphorescent light-emitting compound (R) and the phosphorescent light-emitting compound (G) relative to the weight of the phosphorescent light-emitting compound (B) is 0.001 or more and 0.3 or less.
[8] The composition according to any one of [1] to [7], wherein at least one of the phosphorescent light-emitting compound (B) and the phosphorescent light-emitting compound (G) is an iridium complex.
[9] The composition according to any one of [1] to [8], further comprising a host material.
[10] The composition according to [9], wherein the host material is a polymer compound.
[11] A liquid composition comprising:

the composition according to any one of [1] to [10]; and

a solvent.

[12] A film comprising the composition according to any one of [1] to [10].
[13] A light-emitting device having:

an anode and a cathode; and

an organic layer comprising the composition according to any one of [1] to [10] provided between the anode and the cathode.

14. The light-emitting device according to [13], wherein the light-emitting device emits white color light.

### Effects of the Invention

According to the present invention, a composition useful for manufacturing a light-emitting device that is excellent in external quantum efficiency can be provided. In addition, according to the present invention, a liquid composition, a film, and a light-emitting device containing the composition can be provided.

### EMBODIMENTS FOR CARRYING OUT THE INVENTION

First, terms used in the present specification are described.

“Me” represents a methyl group, “t-Bu” represents a tert-butyl group, and “*” represents an atomic bonding.

The “phosphorescent light-emitting compound” means a compound exhibiting phosphorescent light emission and is preferably a metal complex exhibiting light emission from a triplet excited state. The metal complex exhibiting light emission from a triplet excited state has a central metal atom and a ligand.

Examples of the central metal atom include a metal atom having an atomic number of 40 or more and capable of causing intersystem crossing between a singlet state and a triplet state, the metal atom of which complex has a spin-orbit interaction. Examples of the metal atom include a ruthenium atom, a rhodium atom, a palladium atom, an osmium atom, an iridium atom, and a platinum atom.

Examples of the ligand include: neutral or anionic monodentate ligands; and neutral or anionic multidentate ligands, which form at least one type of bond selected from the group consisting of a coordinate bond and a covalent bond between the ligand and the central metal atom. Examples of the bond between the central metal atom and the ligand include metal-nitrogen bonds, metal-carbon bonds, metal-oxygen bonds, metal-phosphorus bonds, metal-sulfur bonds, and metal-halogen bonds. The multidentate ligand means usually a di- or more dentate and hexa- or less dentate ligand.

The phosphorescent light-emitting compound is commercially available from Aldrich, Luminescence Technology Corp., American Dye Source, Inc., and the like.

As an obtaining method other than the above method, the phosphorescent light-emitting compound can be manufactured by publicly known methods described in literatures such as Journal of American Chemical Society, Vol. 107, 1431-1432 (1985), Journal of American Chemical Society, Vol. 106, 6647-6653 (1984), International Publication No. WO 2011/024761 pamphlet, International Publication No. WO 2002/44189 pamphlet, and Japanese Patent Application Laid-open No. 2006-188673.

The light-emitting spectrum peak of the phosphorescent light-emitting compound can be evaluated, for example, by a method including: dissolving the compound in an organic solvent such as xylene, toluene, and chloroform to prepare a diluted solution of the compound; and measuring the PL spectrum of the diluted solution at room temperature. Here, the light-emitting spectrum peak of the phosphorescent light-emitting compound means a wavelength for the maximum light emission.

Although the “divalent group” is not limited, examples thereof include divalent groups represented by —O—, —S—, —N(R^{A})—, —C(R^{B})₂—, —C(R^{B})═C(R^{B})—, or —C≡C—, arylene groups, divalent aromatic heterocyclic groups, and divalent groups in which two or more types selected from the group consisting of these divalent groups are directly bonded with each other. Examples of the divalent group in which the two or more types are directly bonded with each other include divalent groups represented by —[C(R^{B})₂]₂—, —O—C(R^{B})₂—, —O—[CF(R^{B})₂—]₃—O—, —N(R^{A})—Ar^{A}—, —O—Ar^{A}—, —C(R^{B})₂—C(R^{B})═C(R^{B})—, —[C(R^{B})═C(R^{B})]₂—, —C≡C—[C(R^{B})═C(RB)]—, —C(R^{B})₂—Ar^{A}—, —C(R^{B})═C(R^{B})—Ar^{A}—, —C≡C—Ar^{A}—, and —[Ar^{A}]₂—.

Ar^{A} represents an arylene group or a divalent aromatic hydrocarbon group and when Ar^{A} exists in a plurality, Ar^{A}s may be the same as or different from each other.

R^{B} represents a hydrogen atom or a substituent and when R^{B} is plurally present, R^{B}s may be the same as or different from each other.

The “constitutional unit” means one or more unit(s) included in a polymer compound. The “constitutional unit” is included in a polymer compound preferably as a “repeating unit” (that is, two or more unit structures included in a polymer compound).

The “alkyl group” may have a substituent and may be any one of a linear alkyl group, a branched alkyl group, and a cyclic alkyl group (cycloalkyl group). The number of carbon atoms of the alkyl group without the number of carbon atoms of a substituent is usually 1 to 60 (in the case of a branched alkyl group or a cyclic alkyl group, usually 3 to 60), preferably 1 to 20 (in the case of a branched alkyl group or a cyclic alkyl group, usually 3 to 20).

Examples of the alkyl group include a methyl group, an ethyl group, a propyl group, an isopropyl group, a butyl group, an isobutyl group, a sec-butyl group, a tert-butyl group, a pentyl group, an isoamyl group, a hexyl group, a cyclohexyl group, a heptyl group, an octyl group, a 2-ethylhexyl group, a nonyl group, a decyl group, a 3,7-dimethyloctyl group, and a dodecyl group, and these groups may have a substituent.

The “alkyl group having a fluorine atom” means a group in which at least one hydrogen atom among hydrogen atoms that an alkyl group has is substituted with a fluorine atom and examples thereof include a trifluoromethyl group, a pentafluoroethyl group, a perfluorobutyl group, a perfluorohexyl group, and a perfluorooctyl group.

The “N-valent aromatic hydrocarbon group” means a group remaining after removing N hydrogen atoms directly bonded to a carbon atom making up a ring from an aromatic hydrocarbon.

The “aryl group” means a monovalent aromatic hydrocarbon group.

The “arylene group” means a divalent aromatic hydrocarbon group.

The “aromatic hydrocarbon” may have a substituent unless defined otherwise. The number of carbon atoms of the aromatic hydrocarbon without the number of carbon atoms of a substituent is usually 6 to 60, preferably 6 to 30. Examples of the aromatic hydrocarbon include benzene, naphthalene, anthracene, tetracene, indene, fluorene, benzofluorene, spirobifluorene, indenofluorene, phenanthrene, dihydrophenanthrene, pyrene, perylene, and chrysene.

The aromatic hydrocarbon means a monocyclic or condensed ring aromatic hydrocarbon unless defined otherwise.

The “N-valent aromatic hydrocarbon group having an alkyl group” means an N-valent aromatic hydrocarbon group having one or more alkyl group(s). Unless defined otherwise, the number of substituted alkyl groups is 4 or less, preferably 1 or 2.

The “N-valent aromatic heterocyclic group” means a group remaining after removing N hydrogen atoms directly bonded to a carbon atom or a hetero atom making up a ring from an aromatic heterocyclic compound.

The “heterocyclic compound” is an organic compound having a cyclic structure and containing, as atoms making up the ring, not only a carbon atom, but also a hetero atom such as an oxygen atom, a sulfur atom, a nitrogen atom, a phosphorus atom, a boron atom, a silicon atom, a selenium atom, a tellurium atom, and an arsenic atom.

The “aromatic heterocyclic compound” means a compound exhibiting aromaticity among heterocyclic compounds.

The aromatic heterocyclic compound may have a substituent unless defined otherwise. The number of carbon atoms of the aromatic heterocyclic compound without the number of carbon atoms of a substituent is usually 2 to 60, preferably 2 to 30. Examples of the aromatic heterocyclic compound include: compounds in which the heterocyclic ring itself containing a hetero atom exhibits aromaticity such as oxadiazole, thiadiazole, thiazole, oxazole, thiophene, pyrrole, phosphole, furan, pyridine, pyrazine, pyrimidine, triazine, pyridazine, quinoline, isoquinoline, carbazole, dibenzophosphole, dibenzofuran, dibenzothiophene, and benzothiadiazole; and a compound in which although the heterocyclic ring itself containing a hetero atom does not exhibit aromaticity, an aromatic hydrocarbon is annulated to the heterocyclic ring such as phenoxazine, phenothiazine, dibenzoborole, dibenzosilole, and benzopyran.

The aromatic heterocyclic compound means a monocyclic or condensed ring aromatic heterocyclic compound unless defined otherwise.

The “N-valent aromatic heterocyclic group having an alkyl group” means an N-valent aromatic hydrocarbon group having one or more alkyl group(s). Unless defined otherwise, the number of substituted alkyl groups is 4 or less, preferably 1 or 2.

The “substituent” represents, unless defined otherwise, a halogen atom, a cyano group, an alkyl group, a group represented by —O—R^{A}, a group represented by —N(R^{A})₂, an aryl group, or a monovalent aromatic heterocyclic group and these groups may further have a substituent. When the substituent is plurally present, the substituents may be the same as or different from each other and may be bonded with each other to form a saturated or unsaturated hydrocarbon ring or heterocyclic ring together with the atoms to which the substituents are individually bonded.

The halogen atom may be a fluorine atom, a chlorine atom, a bromine atom, or an iodine atom.

R^{A} represents a hydrogen atom, an alkyl group, an aryl group, or a monovalent aromatic heterocyclic group. When R^{A} is plurally present, R^{A}s may be the same as or different from each other and may be bonded with each other to form a divalent group, which form a ring together with the atoms to which R^{A}s are individually bonded.

The “polymer compound” means a compound having a molecular weight distribution. Unless defined otherwise, the polystyrene-equivalent number average molecular weight thereof is usually 1×10³ to 1×10⁸, preferably 1×10⁴ to 1×10⁶. The polystyrene-equivalent weight average molecular weight thereof is usually 2×10³ to 2×10⁸, because of advantageous film formation properties of the polymer compound, preferably 2×10⁴ to 2×10⁶.

The polymer compound may be any copolymer. Examples of the polymer compound include any one of a block copolymer, a random copolymer, an alternating copolymer, and a graft copolymer.

The weight average molecular weight and the number average molecular weight of the polymer compound are usually determined by a size exclusion chromatography (SEC) measurement. In the SEC measurement, the higher the molecular weight of a component is, the shorter the dissolution time of the component is and the lower the molecular weight of a component is, the longer the elution time of the component is, and using a calibration curve calculated from the elution time of polystyrene (standard sample) having a known molecular weight, the elution time of the sample is converted into the molecular weight of the sample to calculate the weight average molecular weight and the number average molecular weight.

The polymer compound is commercially available from Sigma Aldrich Corp. and the like. Otherwise, the polymer compound can be manufactured using a publicly known polymerization method described in Chem. Rev., Vol. 109, pp. 897 to 1091, (2009), and the like.

The “low molecular weight compound” means a compound having a single molecular weight. Unless defined otherwise, the molecular weight thereof is usually 300 or more and 10,000 or less.

“May have a substituent” means that a part of or all of hydrogen atoms of a group may be substituted with a substituent.

Hereinafter, preferred embodiments of the present invention are described.

[Composition]

The composition of the present invention contains a phosphorescent light-emitting compound (B) that has a light-emitting spectrum peak smaller than 480 nm, a phosphorescent light-emitting compound (G) that has a light-emitting spectrum peak at 480 nm or larger and smaller than 580 nm, and a phosphorescent light-emitting compound (R) that has a light-emitting spectrum peak at 580 nm or larger and smaller than 680 nm.

The composition of the present invention becomes available for manufacturing a white color light-emitting device by controlling a ratio of the weights of the phosphorescent light-emitting compound (B), the phosphorescent light-emitting compound (G), and the phosphorescent light-emitting compound (R). For example, by making the weight of the phosphorescent light-emitting compound (B) more than the weight of the phosphorescent light-emitting compound (G) and by making the weight of the phosphorescent light-emitting compound (G) equal to or more than the weight of the phosphorescent light-emitting compound (R), the composition of the present invention becomes available for manufacturing a white color light-emitting device.

Because the light-emitting device obtained from the composition of the present invention can emit white color light and the external quantum efficiency of the light-emitting device can be enhanced, a ratio of the total weight of the weight of the phosphorescent light-emitting compound (G) and the weight of the phosphorescent light-emitting compound (R) relative to the weight of the phosphorescent light-emitting compound (B) is preferably 0.001 or more and 0.3 or less, more preferably 0.005 or more and 0.2 or less, and further preferably 0.01 or more and 0.1 or less.

Because the light-emitting chromaticity of the light-emitting device obtained from the composition of the present invention can fall within a range of white color and the external quantum efficiency of the light-emitting device can be enhanced, a ratio of the weight of the phosphorescent light-emitting compound (G) relative to the weight of the phosphorescent light-emitting compound (R) is preferably 1 or more and 10 or less, more preferably 1 or more and 7 or less, and further preferably 1 or more and 5 or less.

It can be confirmed that the light-emitting device obtained from the composition of the present invention emits white color light through, for example, measurement of the chromaticity of the light-emitting device under the same condition as in Examples to obtain a chromaticity coordinate (CIE chromaticity coordinate). When X of the chromaticity coordinate is in a range of 0.30 to 0.55 and Y thereof is in a range of 0.30 to 0.55, the light-emitting device can be evaluated as emitting white color light. When X is in a range of 0.30 to 0.50 and Y is in a range of 0.30 to 0.50, the light-emitting device can be evaluated as emitting high quality white color light.

[Phosphorescent Light-Emitting Compound (B)]

Although the phosphorescent light-emitting compound (B) contained in the composition of the present invention is not limited so long as the phosphorescent light-emitting compound (B) is a phosphorescent light-emitting compound that has a light-emitting spectrum peak smaller than 480 nm, because the external quantum efficiency of the light-emitting device obtained from the composition of the present invention can be further enhanced, the phosphorescent light-emitting compound (B) is preferably a metal complex represented by Formula (B-A).

[Chemical Formula 4]

M^{B}(L^{B1})a^{B1}(L^{B2})b^{B1} (B-A)

M^{B} represents a central metal atom. Because the external quantum efficiency of the light-emitting device obtained from the composition of the present invention can be further enhanced, M^{B} is preferably a platinum atom or an iridium atom and more preferably an iridium atom.

L^{B1} represents a ligand and when L^{B1} is plurally present, L^{B1}s may be the same as or different from each other. Because the external quantum efficiency of the light-emitting device obtained from the composition of the present invention can be further enhanced, L^{B1} is preferably an anionic multidentate ligand forming two or more bonds selected from the group consisting of a metal-nitrogen bond and a metal-carbon bond between the ligand and the central metal atom, more preferably a monoanionic didentate ligand forming a metal-nitrogen bond and a metal-carbon bond, and further preferably a monoanionic didentate ligand represented by Formula (LB).

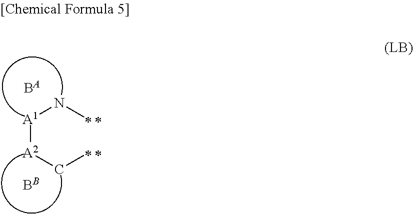

** represents a bond with the central metal atom.

A¹ and A² each independently represent a carbon atom or a nitrogen atom.

The ring B^{A} represents a 5-membered or 6-membered aromatic heterocyclic ring having one or more nitrogen atom(s) and is preferably a 5-membered or 6-membered aromatic heterocyclic ring having one or more and three or less nitrogen atom(s), more preferably a 5-membered aromatic heterocyclic ring having two or more and three or less nitrogen atoms or a 6-membered aromatic heterocyclic ring having one or more and two or less nitrogen atom(s), and further preferably a pyridine ring, a pyrimidine ring, an imidazole ring, or a triazole ring.

The ring B^{B} represents a 5-membered or 6-membered aromatic hydrocarbon ring or a 5-membered or 6-membered aromatic heterocyclic ring and is preferably a 6-membered aromatic hydrocarbon ring or a 6-membered aromatic heterocyclic ring and more preferably a benzene ring.

Because the light-emitting device obtained from the composition of the present invention can exhibit excellent light-emitting spectrum peak, at least any one of the ring B^{A} and the ring B^{B} has preferably a fluorine atom or an alkyl group substituted with a fluorine atom and more preferably a fluorine atom or a trifluoromethyl group.

Because the phosphorescent light-emitting compound (B) can have advantageous solubility in an organic solvent, at least any one of the ring B^{A} and the ring B^{B} has preferably an alkyl group, an aryl group, an aryl group having an alkyl group, or an aromatic heterocyclic group having an alkyl group, more preferably an alkyl group or an aryl group having an alkyl group, and further preferably an alkyl group or a phenyl group having an alkyl group, particularly preferably an alkyl group.

Examples of the “phenyl group having an alkyl group” include a 2-methylphenyl group, 3-methylphenyl group, 4-methylphenyl group, 3-n-butylphenyl group, 4-n-butylphenyl group, 4-tert-butylphenyl group, 3-n-hexylphenyl group, 4-n-hexylphenyl group, 4-n-octylphenyl group, 3,5-dimethylphenyl group, 2,6-dimethylphenyl group, 3-n-hexyl-5-methylphenyl group, 3,5-di-n-hexylphenyl group, and 4-n-butyl-2,6-dimethylphenyl group.

Formula (LB) is preferably a monoanionic didentate ligand represented by Formula (LB-A), Formula (LB-B), or Formula (LB-C) below.

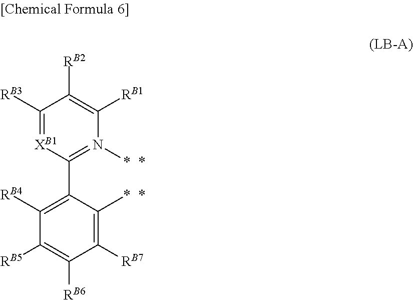

In Formula (LB-A), X^{B1} represents ═C(R^{B8})— or ═N—. ** represents the same as defined above.

R^{B1} to R^{B8} represent a hydrogen atom or a substituent and because the phosphorescent light-emitting compound (B) can have advantageous solubility in an organic solvent, at least any one of R^{B1} to R^{B8} is preferably an alkyl group or a phenyl group having an alkyl group and more preferably an alkyl group.

Because the light-emitting device obtained from the composition of the present invention can exhibit excellent light-emitting spectrum peak, at least any one of R^{B4} to R^{B7} is preferably a fluorine atom or an alkyl group substituted with a fluorine atom and more preferably a fluorine atom or a trifluoromethyl group.

Examples of the monoanionic didentate ligand represented by Formula (LB-A) include ligands represented by Formulae (LB-A1) to (LB-A14) below.

TABLE 1

| FORMULA | X^{B1} | R^{B1} | R^{B2} | R^{B3} | R^{B4} | R^{B5} | R^{B6} | R^{B7} |
|---|---|---|---|---|---|---|---|---|
| (LB-A1) | ═CH— | H | H | H | F | H | F | H |
| (LB-A2) | ═CH— | H | H | H | H | H | F | H |
| (LB-A3) | ═CH— | H | H | OCH₃ | F | H | F | H |
| (LB-A4) | ═CH— | H | H | CH₃ | F | H | F | H |
| (LB-A5) | ═CH— | H | H | C(CH₃)₃ | F | H | F | H |
| (LB-A6) | ═CH— | H | CF₃ | H | H | CF₃ | H | CF₃ |
| (LB-A7) | ═CH— | H | H | H | F | F | F | F |
| (LB-A8) | ═N— | CH₃ | H | H | F | H | F | H |
| (LB-A9) | ═N— | H | n-C₁₀H₂₁ | H | F | H | F | H |
| (LB-A10) | ═N— | H | n-C₁₀H₂₁ | H | H | CF₃ | F | H |
| (LB-A11) | ═N— | H | n-C₇H₁₅ | H | F | H | F | H |
| (LB-A12) | ═N— | H | n-C₁₈H₃₇ | H | F | H | F | H |
| (LB-A13) | ═N— | H | n-C₅H₁₁ | H | F | H | F | H |
| (LB-A14) | ═N— | H | C₂H₅ | H | F | H | F | H |

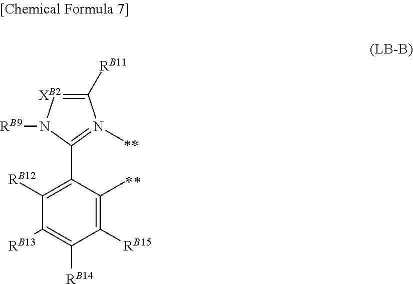

In Formula (LB-B), X^{B2} represents ═C(R^{B10})— or ═N—.

** represents the same as defined above.

R^{B9} represents a hydrogen atom, an alkyl group, an aryl group, or a monovalent aromatic heterocyclic group. Because the phosphorescent light-emitting compound (B) can have advantageous solubility in an organic solvent, R^{B9} is preferably an alkyl group, an aryl group, or an aryl group having an alkyl group, more preferably an alkyl group or an aryl group having an alkyl group, and further preferably an alkyl group or a phenyl group having an alkyl group.

R^{B10} to R^{B15} each independently represent a hydrogen atom or a substituent.

Because the phosphorescent light-emitting compound (B) can have advantageous solubility in an organic solvent, at least any one of R^{B9} to R^{B15} has preferably an alkyl group, an aryl group, or an aromatic heterocyclic group, more preferably an alkyl group, an aryl group having an alkyl group, or a monovalent aromatic heterocyclic group having an alkyl group, and further preferably an alkyl group or a phenyl group having an alkyl group.

Examples of the monoanionic didentate ligand represented by Formula (LB-B) include ligands represented by Formulae (LB-B1) to (LB-B20) below.

TABLE 2

| FORMULA | X^{B2} | R^{B9} | R^{B10} | R^{B11} | R^{B12} | R^{B13} | R^{B14} | R^{B15} |
|---|---|---|---|---|---|---|---|---|
| (LB-B1) | ═C(R^{B10})— | CH₃ | H | H | H | H | H | H |
| (LB-B2) | ═C(R^{B10})— | CH₃ | CH₃ | H | H | H | H | H |
| (LB-B3) | ═C(R^{B10})— | 2,6-dimethylphenyl | H | H | H | H | H | H |
| (LB-B4) | ═C(R^{B10})— | 2,4,6-trimethylphenyl | H | H | H | H | H | H |
| (LB-B5) | ═C(R^{B10})— | 2,4,6-trimethylphenyl | CH₃ | H | H | H | H | H |
| (LB-B6) | ═C(R^{B10})— | 2,4,6-trimethylphenyl | 2,6-dimethylphenyl | H | H | H | H | H |
| (LB-B7) | ═C(R^{B10})— | 2,4,6-trimethylphenyl | H | CH₃ | H | H | H | H |
| (LB-B8) | ═C(R^{B10})— | 2,4,6-trimethylphenyl | H | H | H | phenyl | H | H |
| (LB-B9) | ═C(R^{B10})— | phenyl | H | H | H | H | phenyl | H |
| (LB-B10) | ═N— | CH₃ | — | n-C₃H₇ | H | H | H | H |
| (LB-B11) | ═N— | CH₃ | — | n-C₃H₇ | H | H | F | H |
| (LB-B12) | ═N— | CH₃ | — | n-C₃H₇ | H | H | CF₃ | H |
| (LB-B13) | ═N— | CH₃ | — | n-C₃H₇ | H | CF₃ | H | H |
| (LB-B14) | ═N— | CH₃ | — | n-C₃H₇ | H | phenyl | H | H |
| (LB-B15) | ═N— | CH₃ | — | n-C₃H₇ | H | phenyl | F | H |
| (LB-B16) | ═N— | CH₃ | — | n-C₃H₇ | H | phenyl | CF₃ | H |
| (LB-B17) | ═N— | phenyl | — | n-C₃H₇ | H | H | H | H |
| (LB-B18) | ═N— | phenyl | — | n-C₃H₇ | H | H | phenyl | H |
| (LB-B19) | ═N— | 2,5-dimethylphenyl | — | n-C₃H₇ | H | H | H | H |
| (LB-B20) | ═N— | 3,5-dimethylphenyl | — | n-C₃H₇ | H | H | H | H |

R^{B9} and R^{B12} may be bonded with each other to form a divalent group, which form a ring together with the atoms to which R^{B9} and R^{B12} are individually bonded. Examples of such a structure include the structures below. In the formulae below, **, X^{B2}, R^{B}, R^{B10}, and R^{B13} to R^{B15} represent the same as defined above.

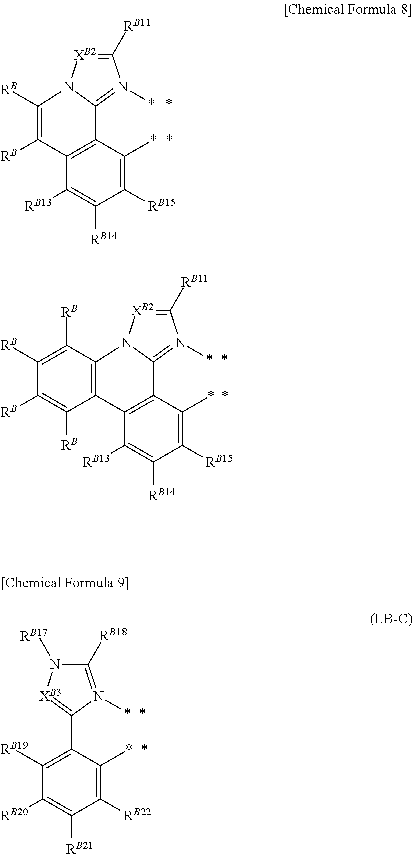

In Formula (LB-C), X^{B2} represents ═C(R^{B16})— or ═N—.

** represents the same as defined above.

R^{B17} represents a hydrogen atom, an alkyl group, an aryl group, or a monovalent aromatic heterocyclic group. R^{B9} is preferably an alkyl group, an aryl group, or an aryl group having an alkyl group and because the phosphorescent light-emitting compound (B) can have advantageous solubility in an organic solvent, R^{B9} is more preferably an alkyl group or an aryl group having an alkyl group.

R^{B16} and R^{B18} to R^{B22} each independently represent a hydrogen atom or a substituent.

Because the phosphorescent light-emitting compound (B) can have advantageous solubility in an organic solvent, at least any one of R^{B16} to R^{B22} is preferably an alkyl group, an aryl group, an aryl group having an alkyl group, or a monovalent aromatic heterocyclic group having an alkyl group, more preferably an alkyl group or an aryl group having an alkyl group, and further preferably an alkyl group.

Examples of the monoanionic didentate ligand represented by Formula (LB-C) include ligands represented by Formulae (LB-C1) to (LB-C22) below.

TABLE 3

| FORMULA | X^{B2} | R^{B16} | R^{B17} | R^{B18} | R^{B19} | R^{B20} | R^{B21} | R^{B22} |
|---|---|---|---|---|---|---|---|---|
| (LB-C1) | ═C(R^{B16})— | H | CH₃ | H | H | H | H | H |
| (LB-C2) | ═C(R^{B16})— | H | phenyl | H | H | H | H | H |
| (LB-C3) | ═C(R^{B16})— | H | 2,6-dimethylphenyl | H | H | H | H | H |
| (LB-C4) | ═N— | — | n-C₆H₁₃ | CH₃ | H | H | H | H |
| (LB-C5) | ═N— | — | n-C₆H₁₃ | n-C₃H₇ | H | H | H | H |
| (LB-C6) | ═N— | — | n-C₆H₁₃ | n-C₃H₇ | H | H | F | H |
| (LB-C7) | ═N— | — | n-C₆H₁₃ | n-C₃H₇ | H | H | CF₃ | H |
| (LB-C8) | ═N— | — | n-C₆H₁₃ | n-C₃H₇ | F | H | F | H |
| (LB-C9) | ═N— | — | 3,5-dimethylphenyl | CH₃ | H | H | H | H |
| (LB-C10) | ═N— | — | 2,5-dimethylphenyl | CH₃ | H | H | H | H |
| (LB-C11) | ═N— | — | n-C₆H₁₃ | n-C₃H₇ | H | phenyl | H | H |
| (LB-C12) | ═N— | — | 3,5-di-tert-butyl-phenyl | n-C₃H₇ | H | phenyl | H | H |
| (LB-C13) | ═N— | — | 2,5-dimethylphenyl | n-C₃H₇ | H | phenyl | H | H |
| (LB-C14) | ═N— | — | 2,4,6-trimethylphenyl | n-C₃H₇ | H | phenyl | H | H |
| (LB-C15) | ═N— | — | phenyl | n-C₃H₇ | H | H | H | H |
| (LB-C16) | ═N— | — | phenyl | n-C₃H₇ | H | H | CF₃ | H |
| (LB-C17) | ═N— | — | phenyl | n-C₃H₇ | H | H | F | H |
| (LB-C18) | ═N— | — | phenyl | n-C₃H₇ | H | tert-butyl | H | H |
| (LB-C19) | ═N— | — | phenyl | n-C₃H₇ | H | 4-tert-butylphenyl | H | H |
| (LB-C20) | ═N— | — | phenyl | n-C₃H₇ | H | 2,6-dimetnylphenyl | H | H |
| (LB-C21) | ═N— | — | phenyl | n-C₃H₇ | H | 3,5-di-tert-butyl-phenyl | H | H |
| (LB-C22) | ═N— | — | phenyl | n-C₃H₇ | H | phenyl | H | H |

L^{B2} represents a ligand. However, L^{B2} is different from L^{B1}. L^{B2} is preferably a neutral didentate ligand or an anionic didentate ligand, more preferably an anionic didentate ligand, and further preferably a monoanionic didentate ligand. When L^{B2} is plurally present, L^{B2}s may be the same as or different from each other.

L^{B2} is preferably a didentate ligand forming a metal-nitrogen bond and a metal-carbon bond between the ligand and the central metal atom, a didentate ligand forming a metal-nitrogen bond and a metal-oxygen bond between the ligand and the central metal atom, a didentate ligand forming two metal-oxygen bonds between the ligand and the central metal atom, or a didentate ligand forming two metal-nitrogen bonds between the ligand and the central metal atom.

Examples of L^{B2} include the following ligands. In the formulae below, *4, R^{A}, and R^{B} represent the same as defined above.

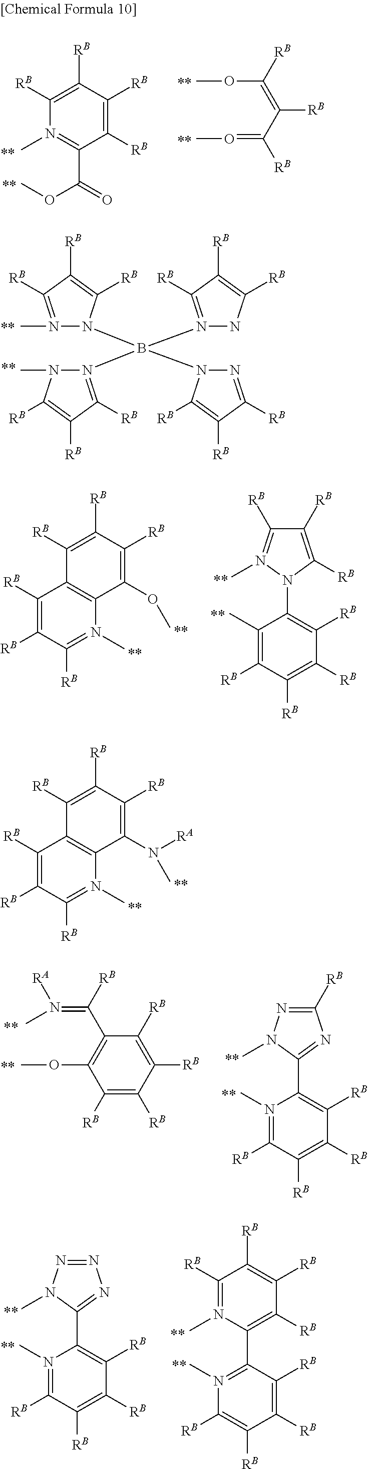

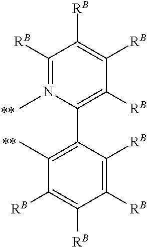

L^{B2} is preferably the ligands represented by Formulae (L-1) to (L-4) below.

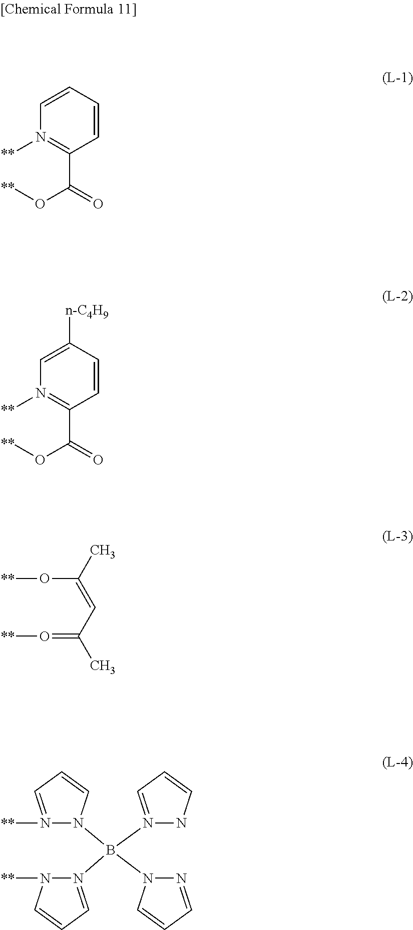

a^{B1} represents an integer of 1 or more and b^{B1} represents an integer of 0 or more, with the proviso that a^{B1}+a^{B1} exists so as to satisfy a valence that the metal atom M^{B} has. For example, when M^{B} is iridium (III) and L^{B1} and L^{B2} are monoanionic didentate ligands, a^{B1}+b^{B1} represents 3.

When M^{B} is an iridium atom, it is preferred that a^{B1}+b^{B1} is 3 and it is more preferred that a^{B1} is 2 or 3.

When M^{B} is an iridium atom and a^{B1} is 2, because the synthesis of the phosphorescent light-emitting compound (B) is easy, two L^{B1}s are preferably the same as each other.

When M^{B} is an iridium atom and a^{B1} is 3, because the synthesis of the phosphorescent light-emitting compound (B) is easy, three L^{B1}S are preferably the same as each other or two L^{B1}S among three L^{B1}S are preferably the same as each other.

When M^{B} is a platinum atom, a^{B1}+b^{B1} is preferably 2.

Examples of the phosphorescent light-emitting compound (B) include compounds represented by Formulae (B-A1) to (B-A16) below.

[Chemical Formula 12]

Ir(L^{EB1})₃ (B-A1)

In Formula (B-A1), L^{EB1} represents a monoanionic didentate ligand represented by Formulae (LB-A1) to (LB-A14), (LB-B1) to (LB-B20), and (LB-C1) to (LB-C22) and L^{EB1}s are the same as each other.

[Chemical Formula 13]

Pt(L^{EB1})₂ (B-A2)

In Formula (B-A2), L^{EB1} represents the same as defined above.

TABLE 4

| FORMULA | M^{B} | L^{B1} | a^{B1} | L^{B2} | b^{B1} |
|---|---|---|---|---|---|
| (B-A3) | Ir | (LB-A1) | 2 | (L-1) | 1 |
| (B-A4) | Ir | (LB-A1) | 2 | (L-4) | 1 |
| (B-A5) | Ir | (LB-A1) | 2 | (L-3) | 1 |
| (B-A6) | Ir | (LB-A1) | 2 | (LB-A2) | 1 |
| (B-A7) | Ir | (LB-A9) | 2 | (L-1) | 1 |
| (B-A8) | Ir | (LB-A9) | 2 | (L-3) | 1 |
| (B-A9) | Ir | (LB-A10) | 2 | (L-1) | 1 |
| (B-A10) | Ir | (LB-A9) | 2 | (L-2) | 1 |
| (B-A11) | Ir | (LB-A11) | 2 | (L-1) | 1 |
| (B-A12) | Ir | (LB-A13) | 2 | (L-1) | 1 |
| (B-A13) | Ir | (LB-A12) | 2 | (L-1) | 1 |
| (B-A14) | Ir | (LB-A9) | 2 | (L-4) | 1 |
| (B-A15) | Ir | (LB-A14) | 2 | (L-1) | 1 |
| (B-A16) | Pt | (LB-A1) | 1 | (L-3) | 1 |

Because the phosphorescent light-emitting compound (B) can enhance color reproducibility of the light-emitting device obtained from the composition of the present invention, the phosphorescent light-emitting compound (B) is preferably a phosphorescent light-emitting compound that has a light-emitting spectrum peak at 420 nm or larger.

[Phosphorescent Light-Emitting Compound (G)]

Although the phosphorescent light-emitting compound (G) contained in the composition of the present invention is not limited so long as the phosphorescent light-emitting compound (G) is a phosphorescent light-emitting compound that has a light-emitting spectrum peak at 480 nm or larger and smaller than 580 nm, because the external quantum efficiency of the light-emitting device obtained from the composition of the present invention can be further enhanced, the phosphorescent light-emitting compound (G) is more preferably a metal complex represented by Formula (G-A).

[Chemical Formula 14]

M^{G}(L^{G1})a^{G1}(L^{G2})b^{G1} (G-A)

M^{G} represents a central metal atom. Because the external quantum efficiency of the light-emitting device obtained from the composition of the present invention can be further enhanced, M^{G} is preferably a platinum atom or an iridium atom, and more preferably an iridium atom.

L^{G1} represents a ligand and when L^{G1} is plurally present, L^{G11}s may be the same as or different from each other. Because the external quantum efficiency of the light-emitting device obtained from the composition of the present invention can be further enhanced, L^{G1} is preferably an anionic multidentate ligand forming two or more bonds selected from the group consisting of a metal-nitrogen bond and a metal-carbon bond between the ligand and the central metal atom, more preferably a monoanionic didentate ligand forming a metal-nitrogen bond and a metal-carbon bond, and further preferably a monoanionic didentate ligand represented by Formula (LG).

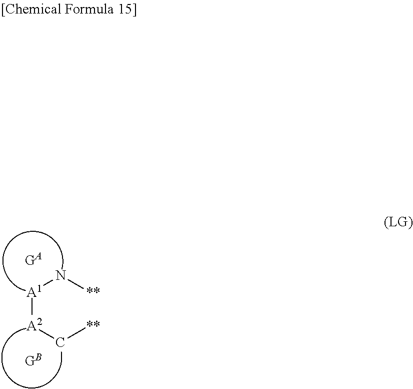

In Formula (LG), C, N, A¹, A², and ** represent the same as defined above.

The ring G^{A} represents a 5-membered or 6-membered aromatic heterocyclic ring having one or more nitrogen atom(s) and is preferably a 5-membered or 6-membered aromatic heterocyclic ring having one or more and three or less nitrogen atom(s), more preferably a 6-membered aromatic heterocyclic ring having one or more and three or less nitrogen atom(s), and further preferably a pyridine ring.

The ring G^{B} represents a 5-membered or 6-membered aromatic hydrocarbon ring or a 5-membered or 6-membered aromatic heterocyclic ring and is preferably a 6-membered aromatic hydrocarbon ring or a 6-membered aromatic heterocyclic ring and more preferably a benzene ring.

Because the phosphorescent light-emitting compound (G) can have advantageous solubility in an organic solvent, at least any one of the ring G^{A} and the ring G^{B} has preferably an alkyl group, an aryl group, or a monovalent aromatic heterocyclic group, more preferably an alkyl group, an aryl group having an alkyl group, or a monovalent aromatic heterocyclic group having an alkyl group, and further preferably an alkyl group or a phenyl group having an alkyl group.

The didentate ligand represented by Formula (LG) is preferably a monoanionic didentate ligand represented by Formula (LG-A).

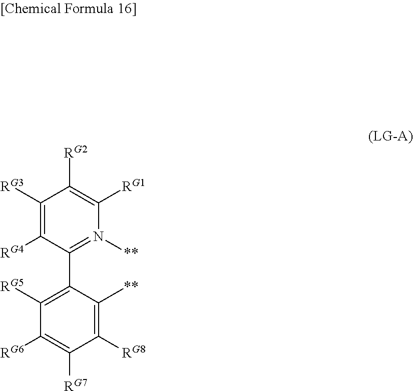

In Formula (LG-A), ** represents the same as defined above.

R^{G1} to R^{G8} represent a hydrogen atom or a substituent and because the phosphorescent light-emitting compound (G) can have advantageous solubility in an organic solvent, at least any one of R^{G1} to R^{G8} is preferably an alkyl group, an aryl group, or an aromatic heterocyclic group, more preferably an alkyl group, an aryl group having an alkyl group, or an aromatic heterocyclic group having an alkyl group, and further preferably an alkyl group or a phenyl group having an alkyl group.

Examples of the didentate ligand represented by Formula (LG-A) include ligands represented by Formulae (LG-A1) to (LG-A10) below.

TABLE 5

| FORMULA | R^{G1} | R^{G2} | R^{G3} | R^{G4} | R^{G5} | R^{G6} | R^{G7} | R^{G8} |
|---|---|---|---|---|---|---|---|---|
| (LG-A1) | H | H | H | H | H | H | H | H |
| (LG-A2) | H | H | H | H | H | n-C₆H₁₃ | H | H |
| (LG-A3) | H | H | H | H | H | H | n-C₈H₁₇ | H |
| (LG-A4) | H | H | H | H | CH₃ | H | H | H |
| (LG-A5) | H | CH₃ | H | H | H | C(CH₃)₃ | H | H |
| (LG-A6) | H | H | CH₃ | H | H | C(CH₃)₃ | H | H |
| (LG-A7) | H | H | H | H | H | 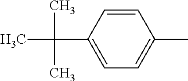 | H | H |
| (LG-A8) | H | H | H | H | H | 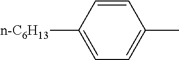 | H | H |
| (LG-A9) | H | C(CH₃)₃ | H | H | H | 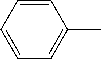 | H | H |
| (LG-A10) | H | H | 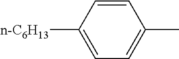 | H | H | 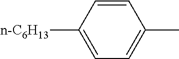 | H | H |

L^{G2} represents a ligand. However, L^{G2} is different from L^{G1}. The definition and examples of L^{G2} are the same as the definition and examples of L^{B2} above.

a^{G1} represents an integer of 1 or more and b^{G1} represents an integer of 0 or more. a^{G1}+a^{G1} exists so as to satisfy a valence that the metal atom M^{G} has. The definition and examples of a^{G1} are the same as the definition and examples of a^{B1}. The definition and examples of b^{G1} are the same as the definition and examples of b^{B1}.

Because the synthesis of the phosphorescent light-emitting compound (G) is easy, when M^{G} is an iridium atom and a^{G1} is 2, two L^{G1}s are preferably the same as each other.

Because the synthesis of the phosphorescent light-emitting compound (G) is easy, when M^{G} is an iridium atom and a^{G1} is 3, three L^{G1}s are preferably the same as each other or two L^{G1}s among three L^{G1}s are preferably the same as each other.

When M^{G} is a platinum atom, a^{G1}+b^{G1} is preferably 2.

Examples of the phosphorescent light-emitting compound (G) include compounds represented by Formulae (G-A1) to (G-A4) below.

[Chemical Formula 17]

Ir(L^{EG1})₃ (G-A1)

In Formula (G-A1), L^{EG1} represents a monoanionic didentate ligand represented by Formulae (LG-A1) to (LG-A10) and L^{EG1}s are the same as each other.

[Chemical Formula 18]

Pt(L^{EG1})₂ (G-A2)

In Formula (G-A2), L^{EG1} represents the same as defined above.

[Chemical Formula 19]

Ir(LG-A1)₂(LG-3) (G-A3)

[Chemical Formula 20]

Pt(LG-A1)(LG-3) (G-A4)

[Phosphorescent Light-Emitting Compound (R)]

The phosphorescent light-emitting compound (R) contained in the composition of the present invention is a phosphorescent light-emitting compound that has a light-emitting spectrum peak at 580 nm or larger and smaller than 680 nm and has a dendrimer structure.

The “phosphorescent light-emitting compound having a dendrimer structure” means a phosphorescent light-emitting compound having a ligand that is a ligand having a substituent having a dendrimer structure. Examples of the phosphorescent light-emitting compound having a dendrimer structure include structures described in literatures such as WO 02/067343, Japanese Patent Application Laid-open No. 2003-231692, WO 2003/079736, and WO 2006/097717.

The substituent having a dendrimer structure is preferably a substituent containing a branched structure represented by Formula (GD-A).

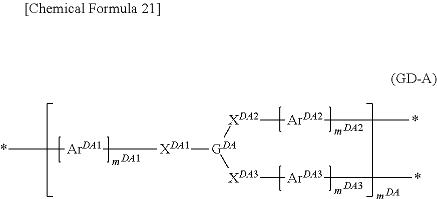

In Formula (GD-A), G^{DA} represents a boron atom, a nitrogen atom, a phosphorus atom, a trivalent aromatic hydrocarbon group, or a trivalent aromatic heterocyclic group and is preferably a nitrogen atom, a trivalent aromatic hydrocarbon group, or a trivalent aromatic heterocyclic group and more preferably a trivalent aromatic hydrocarbon group or a trivalent aromatic heterocyclic group. When G^{DA} is plurally present, although G^{DA}s may be the same as or different from each other, G^{DA}s are preferably the same as each other.

The trivalent aromatic hydrocarbon group represented by G^{DA} is preferably a group remaining after removing three hydrogen atoms directly bonded to a carbon atom making up a benzene ring and more preferably a group represented by Formula (GDA-1).

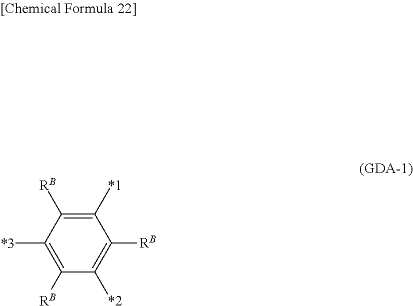

In Formula (GDA-1), *1, *2, and *3 represent individually a bond with X^{DA1}, X^{DA2}, and X^{DA3}. R^{B} represents the same as defined above.

The trivalent aromatic heterocyclic group represented by G^{DA} is preferably a group remaining after removing three hydrogen atoms directly bonded to a carbon atom or a hetero atom making up a carbazole ring, a pyridine ring, a pyrimidine ring, or a triazine ring and more preferably a group represented by Formulae (GDA-2) to (GDA-5) below. In Formulae (GDA-2) to (GDA-5), R^{B}, *1, *2, and *3 represent the same as defined above.

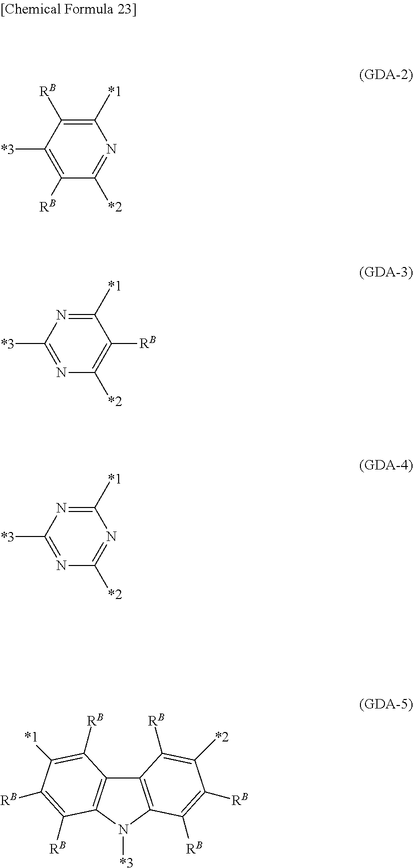

X^{DA1}, X^{DA2}, and X^{DA3} each independently represent a single bond or a divalent group. When X^{DA1} is plurally present, although X^{DA1}s may be the same as or different from each other, X^{DA1}s are preferably the same as each other. When X^{DA2} is plurally present, although X^{DA2}s may be the same as or different from each other, X^{DA2}s are preferably the same as each other. When X^{DA3} is plurally present, although X^{DA3}s may be the same as or different from each other, X^{DA3}s are preferably the same as each other. X^{DA2} and X^{DA3} are preferably the same as each other and X^{DA1}, X^{DA2}, and X^{DA3} are more preferably the same as each other.

When G^{DA} is a boron atom, a nitrogen atom, or a phosphorus atom, X^{DA1}, X^{DA2}, and X^{DA3} are preferably a single bond.

When G^{DA} is a trivalent aromatic hydrocarbon group or a trivalent aromatic heterocyclic group, X^{DA1}, X^{DA2}, and X^{DA3} are preferably a single bond, one divalent group selected from the group consisting of a divalent group represented by —O—, a divalent group represented by —C(R^{BDA})₂—, a divalent group represented by —C(R^{BDA})═C(R^{BDA})—, and a divalent group represented by —C≡C—, or a divalent group in which two or more types selected from the above group are directly bonded with each other, more preferably a single bond, a divalent group represented by —O—, or a divalent group represented by —C(R^{BDA})═C(R^{BDA})— and further preferably a single bond.

R^{BDA} represents a hydrogen atom or a substituent and is preferably a hydrogen atom, an alkyl group, an aryl group, or a monovalent aromatic heterocyclic group, more preferably a hydrogen atom or an alkyl group, and further preferably a hydrogen atom. R^{BDA}s may be the same as or different from each other.

Ar^{DA1}, Ar^{DA2}, and Ar^{DA3} each independently represent an arylene group or a divalent aromatic heterocyclic group and are preferably a group remaining after removing two hydrogen atoms directly bonded to a carbon atom or a hetero atom making up a benzene ring, a fluorene ring, a carbazole ring, a dibenzofuran ring, a pyridine ring, a pyrimidine ring, or a triazine ring, more preferably a phenylene group, a fluorene-diyl group, or a carbazole-diyl group, and further preferably a divalent group represented by Formulae (Ar-1) to (Ar-3) below, particularly preferably a divalent group represented by Formula (Ar-1). When Ar^{DA1} is plurally present, although Ar^{DA1}s may be the same as or different from each other, Ar^{DA1}s are preferably the same as each other. When Ar^{DA2} is plurally present, although Ar^{DA2}s may be the same as or different from each other, Ar^{DA2}s are preferably the same as each other. When Ar^{DA3} is plurally present, although Ar^{DA3}s may be the same as or different from each other, Ar^{DA3}s are preferably the same as each other. Ar^{DA2} and Ar^{DA3} are preferably the same as each other and Ar^{DA1}, Ar^{DA2}, and Ar^{DA3} are more preferably the same as each other.

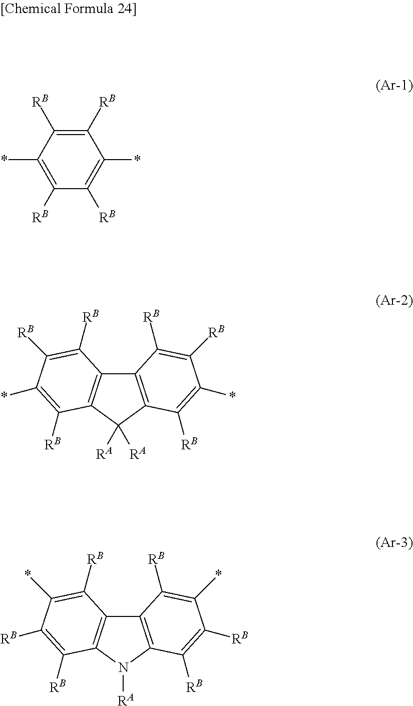

In Formulae (Ar-1) to (Ar-3), R^{A} and R^{B} represent the same as defined above.

m^{DA1}, m^{DA2}, and m^{DA3} each independently represent an integer of 0 or more, usually 10 or less, preferably 5 or less, more preferably 3 or less, and further preferably 0 or 1. When m^{DA1} is plurally present, although m^{DA1}s may be the same as or different from each other, m^{DA1}s are preferably the same as each other. When m^{DA2} is plurally present, although m^{DA2}s may be the same as or different from each other, m^{DA2}s are preferably the same as each other. When m^{DA3} is plurally present, although m^{DA3}s may be the same as or different from each other, m^{DA3}s are preferably the same as each other. m^{DA2} and m^{DA3} are preferably the same as each other and m^{DA1}, m^{DA2}, and m^{DA3} are more preferably the same as each other.

n^{DA} represents an integer of 1 or more, usually 10 or less, because the synthesis of the phosphorescent light-emitting compound (R) is easy, preferably 5 or less, more preferably 3 or less, and further preferably 2 or less.

The substituent having a dendrimer structure is preferably a substituent represented by Formula (D-A) below or a substituent represented by Formula (D-B) below.

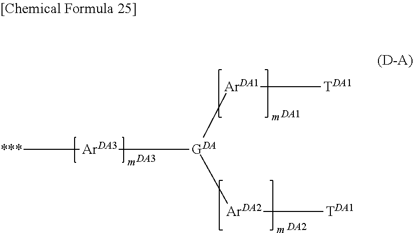

In Formula (D-A), G^{DA}, Ar^{DA1}, Ar^{DA2}, Ar^{DA3}, m^{DA1}, m^{DA2}, and m^{DA3} are the same as defined above.

*** represents a bond with a ligand.

T^{DA1} represents an aryl group or a monovalent aromatic heterocyclic group and is preferably a phenyl group, a naphthyl group, a fluorenyl group, a carbazolyl group, a dibenzofuranyl group, a pyridyl group, a pyrimidinyl group, or a triazinyl group, more preferably a monovalent group represented by Formulae (TD-1) to (TD-3) below, and further preferably a monovalent group represented by Formula (TD-1). Although T^{DA1}s may be the same as or different from each other, T^{DA1}s are preferably the same as each other.

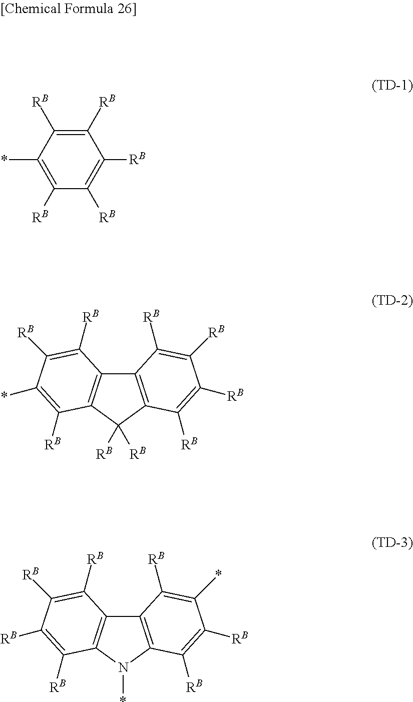

In Formulae (TD-1) to (TD-3), R^{B} represents the same as defined above.

Because the phosphorescent light-emitting compound (R) can have advantageous solubility in an organic solvent, an aryl group and a monovalent aromatic heterocyclic group represented by T^{DA1} have preferably one or more alkyl group or one or more group represented by —O—R^{c}, more preferably one to three alkyl group(s) or one to three group(s) represented by —O—R^{c}, and further preferably one or two alkyl group(s).

R^{C} represents an alkyl group. When R^{C} is plurally present, R^{C} may be the same as or different from each other.

R^{C} is preferably a tert-butyl group, an n-hexyl group, or a 2-ethylhexyl group.

Examples of the aryl group and the monovalent aromatic heterocyclic group that have one or more alkyl group(s) or one or more group represented by —O—R^{C} preferred as T^{DA1} include groups represented by formulae below.

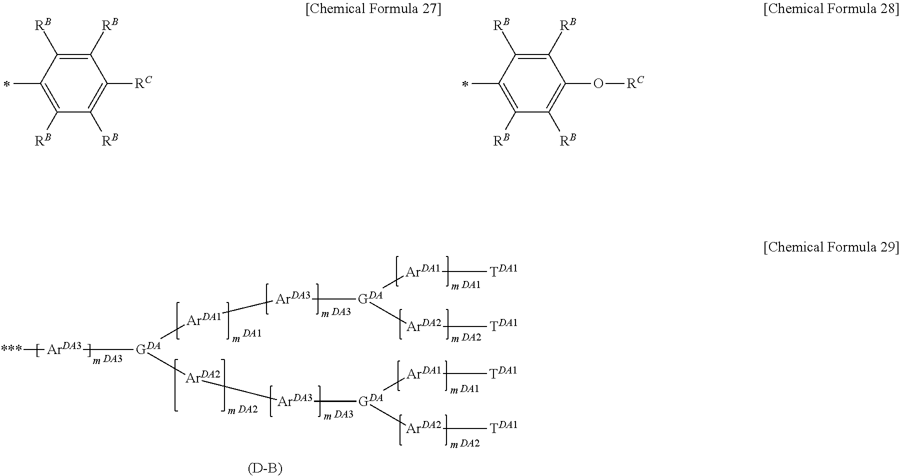

In Formula (D-B), G^{DA}, Ar^{DA1}, Ar^{DA2}, Ar^{DA3}, m^{DA1}, m^{DA2}, m^{DA3}, ***, and T^{DA1} represent the same as defined above.

Examples of the substituent having a dendrimer structure include structures below. In the structures below, *** represents the same as defined above. R represents a hydrogen atom or a substituent. R^{B} represents the same as defined above, and it is preferred that R^{B} is a hydrogen atom, an alkyl group, or a group represented by —O—R^{c} and it is more preferred that at least one R^{B} is an alkyl group.

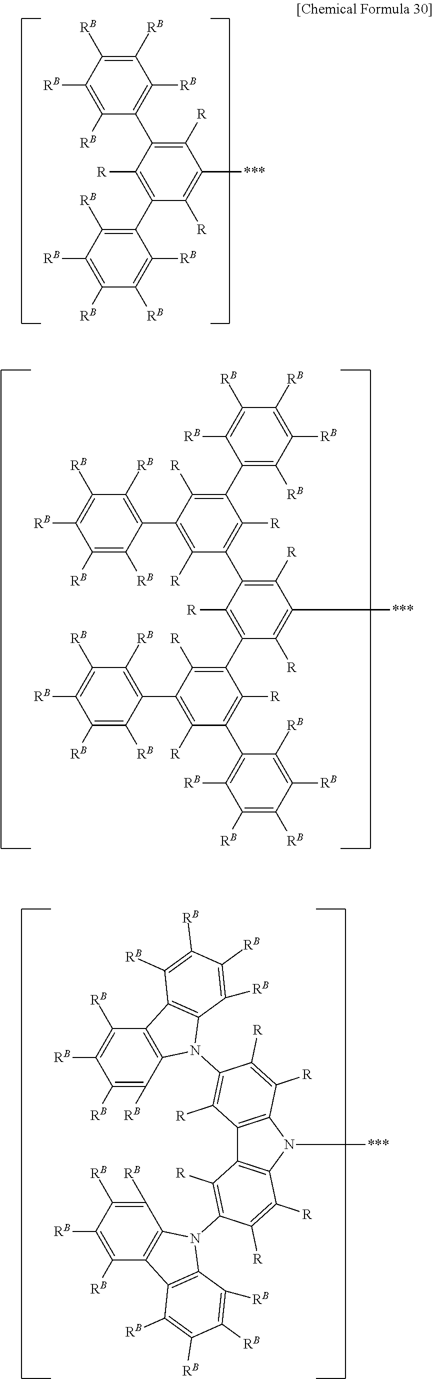

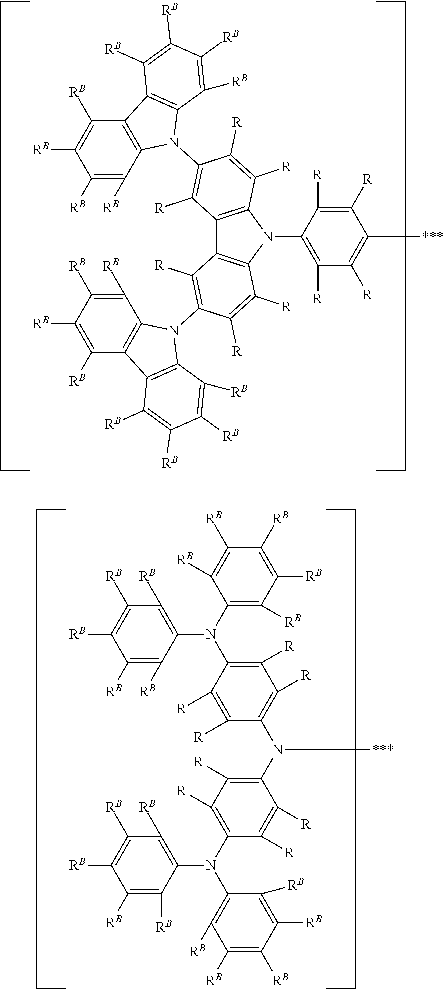

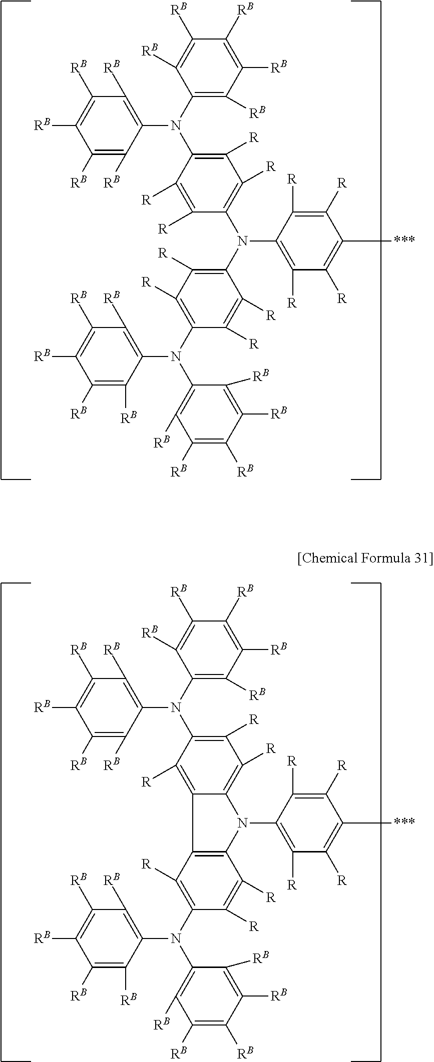

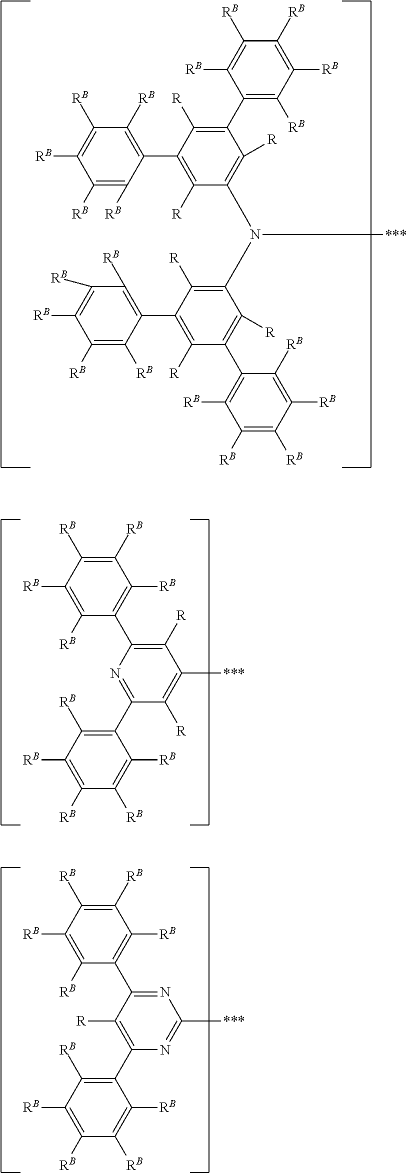

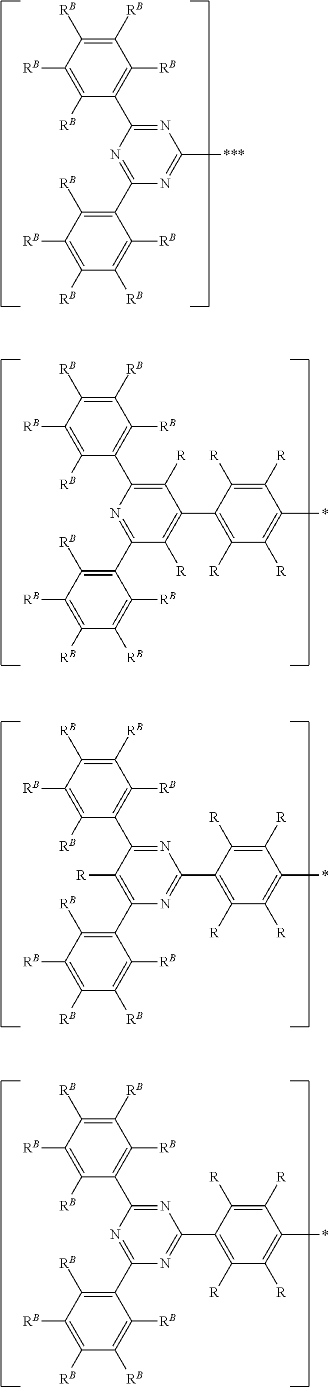

Because the external quantum efficiency of the light-emitting device obtained from the composition of the present invention can be further enhanced, the phosphorescent light-emitting compound (R) is preferably a metal complex represented by Formula (R-A).

[Chemical Formula 32]

M^{R}(L^{R1})a^{R1}(L^{R2})b^{R1} (R-A)

M^{R} represents a central metal atom. Because the external quantum efficiency of the light-emitting device obtained from the composition of the present invention can be further enhanced, M^{R} is preferably a platinum atom or an iridium atom and more preferably an iridium atom.

L^{R1} represents a ligand that has a substituent having a dendrimer structure. When L^{R1} is plurally present, L^{R1}s may be the same as or different from each other. Because the external quantum efficiency of the light-emitting device obtained from the composition of the present invention can be further enhanced, L^{R1} is preferably an anionic multidentate ligand forming two or more bonds selected from the group consisting of a metal-nitrogen bond and a metal-carbon bond between the ligand and the central metal atom, more preferably a monoanionic didentate ligand forming a metal-nitrogen bond and a metal-carbon bond, and further preferably a monoanionic didentate ligand represented by Formula (LR).

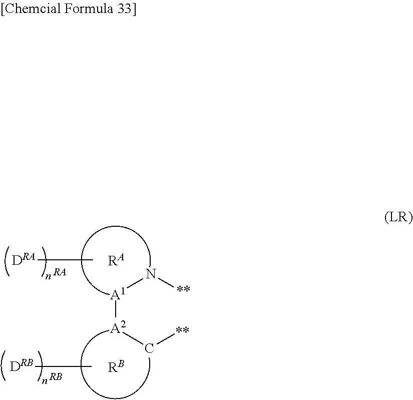

In Formula (LR), C, N, A¹, A², and ** represent the same as defined above.

The ring R^{A} represents a 5-membered or 6-membered aromatic heterocyclic ring having one or more nitrogen atom(s) and is preferably a 5-membered or 6-membered aromatic heterocyclic ring having one or more and three or less nitrogen atom(s), more preferably a 6-membered aromatic heterocyclic ring having one or more and two or less nitrogen atom(s), and further preferably a pyridine ring, a quinoline ring, or an isoquinoline ring.

The ring R^{B} represents a 5-membered or 6-membered aromatic hydrocarbon ring or a 5-membered or 6-membered aromatic heterocyclic ring and is preferably a 6-membered aromatic hydrocarbon ring or a 5-membered aromatic heterocyclic ring, more preferably an indole ring, a benzofuran ring, a benzothiophene ring, a benzene ring, or a naphthalene ring, and further preferably a benzene ring.

D^{RA} and D^{RB} each independently represent a substituent having a dendrimer structure. When D^{RA} and D^{RB} are plurally present, D^{RA}s or D^{RB}s may be the same as or different from each other.

n^{RA} and n^{RB} each independently represent an integer of 0 or more, with the proviso that n^{RA}+n^{RB} is 1 or more. Because the synthesis of the phosphorescent light-emitting compound (R) is easy, n^{RA}+n^{RB} is preferably 4 or less and more preferably 1 or 2.

The monoanionic didentate ligand represented by Formula (LR) is preferably a monoanionic didentate ligand represented by Formulae (LR-A) to (LR-D).

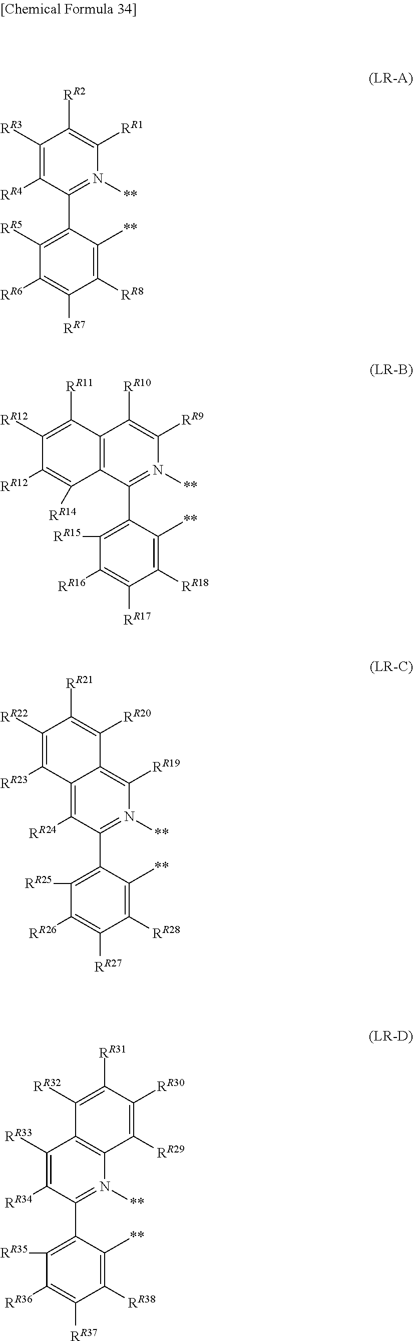

In Formulae (LR-A) to (LR-D), ** represents the same as defined above.

In Formula (LR-A), R^{R1} to R^{R8} each independently represent a hydrogen atom, a substituent, or a substituent having a dendrimer structure, with the proviso that at least any one of R^{R1} to R^{R8} represents a substituent having a dendrimer structure. It is preferred that at least any one of R^{R1}, R^{R6}, and R^{R7} is a substituent having a dendrimer structure and it is more preferred that at least any one of R^{R1} and R^{R6} is a substituent having a dendrimer structure.

In Formula (LR-B), R^{R9} to R^{R18} each independently represent a hydrogen atom, a substituent, or a substituent having a dendrimer structure, with the proviso that at least any one of R^{R9} to R^{R18} represents a substituent having a dendrimer structure. It is preferred that at least any one of R^{R16} and R^{R17} is a substituent having a dendrimer structure.

In Formula (LR-C), R^{R19} to R^{R28} each independently represent a hydrogen atom, a substituent, or a substituent having a dendrimer structure, with the proviso that at least any one of R^{R19} to R^{R28} represents a substituent having a dendrimer structure. It is preferred that at least any one of R^{R26} and R^{R27} is a substituent having a dendrimer structure.

In Formula (LR-D), R^{R29} to R^{R38} each independently represent a hydrogen atom, a substituent, or a substituent having a dendrimer structure, with the proviso that at least any one of R^{R29} to R^{R38} represents a substituent having a dendrimer structure. It is preferred that at least any one of R^{R36} and R^{R37} is a substituent having a dendrimer structure.

L^{R2} represents a ligand. However, L^{R2} is different from L^{R1}. Although the definition and examples of L^{R2} are the same as the definition and examples of L^{B2} above, L^{R2} is preferably not only a ligand represented by Formulae (L-1) to (L-4), but also a ligand represented by Formulae (L-5) to (L-9) below. In Formulae (L-5) to (L-9), R^{c} and ** represent the same as defined above.

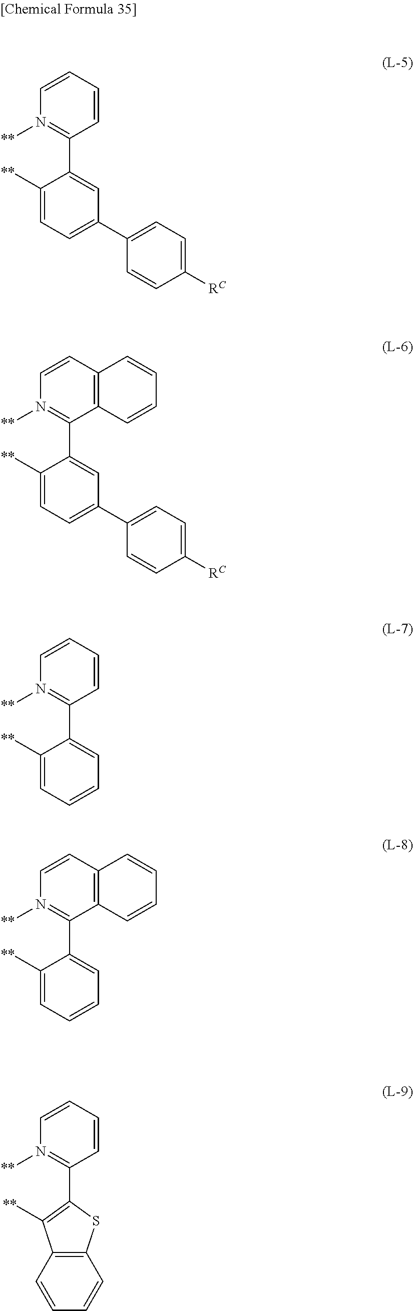

a^{R1} represents an integer of 1 or more and b^{R1} represents an integer of 0 or more. a^{R1}+a^{R1} exists so as to satisfy a valence that the metal atom M^{R} has. The definition and examples of a^{R1} are the same as the definition and examples of a^{B1}.

Because the synthesis of the phosphorescent light-emitting compound (R) is easy, when M^{R} is an iridium atom and a^{R1} is 2, two L^{R1}s are preferably the same as each other.

Because the synthesis of the phosphorescent light-emitting compound (R) is easy, when M^{R} is an iridium atom and a^{R1} is 3, three L^{R1}s are preferably the same as each other or two L^{R1}s among three L^{R1}s are preferably the same as each other.

When M^{R} is a platinum atom, a^{R1}+b^{R1} is preferably 2.

Examples of the phosphorescent light-emitting compound (R) include structures below.

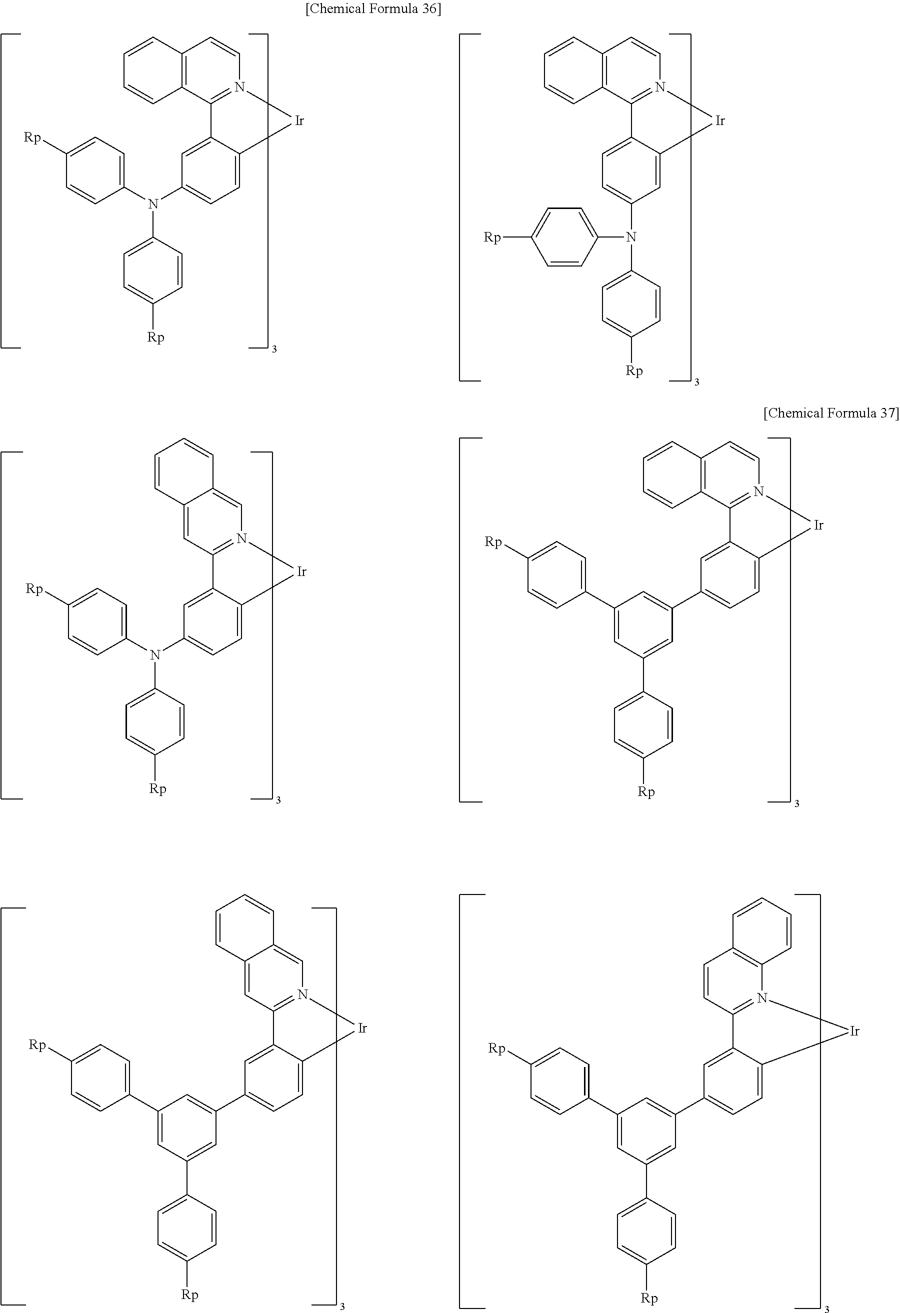

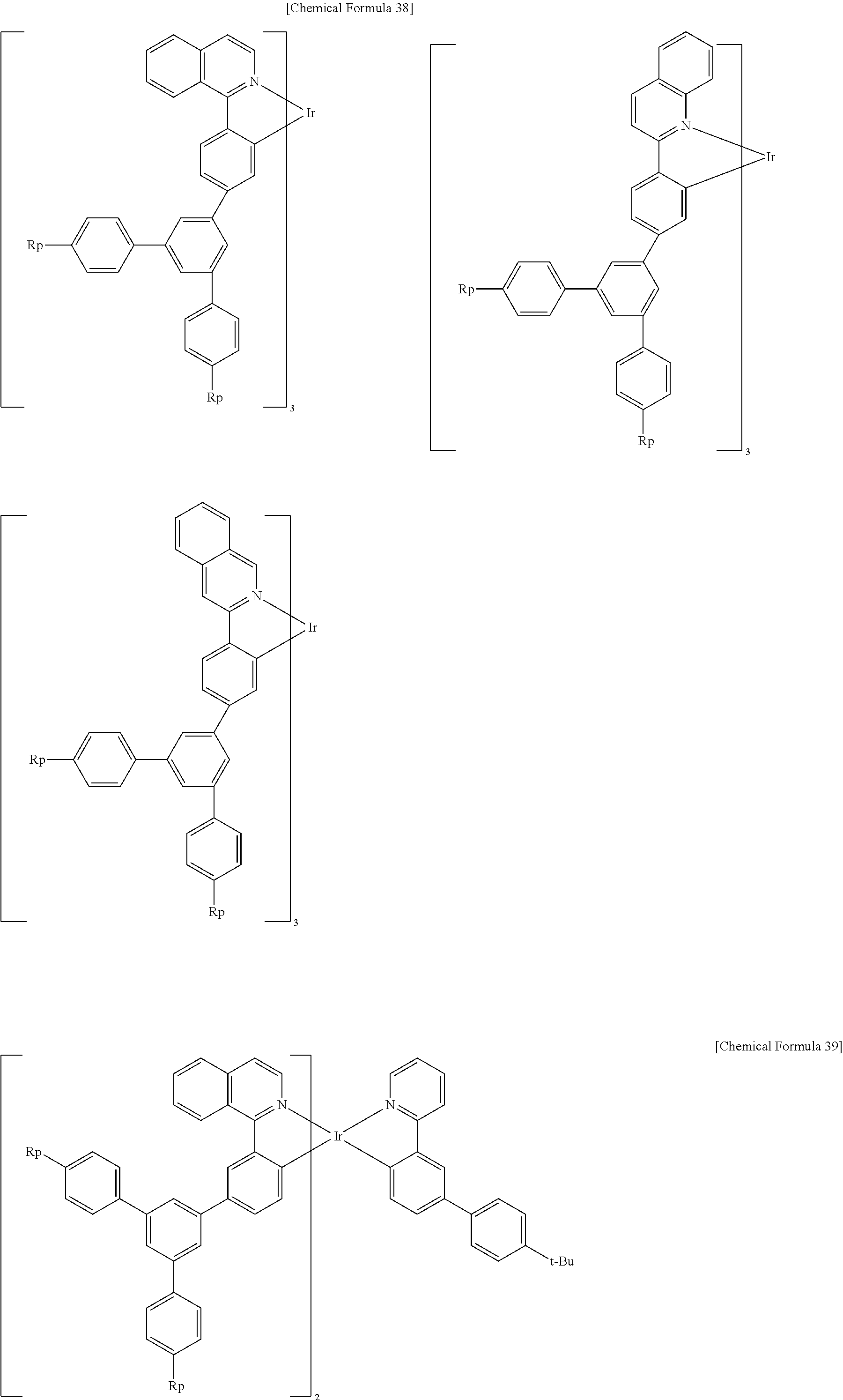

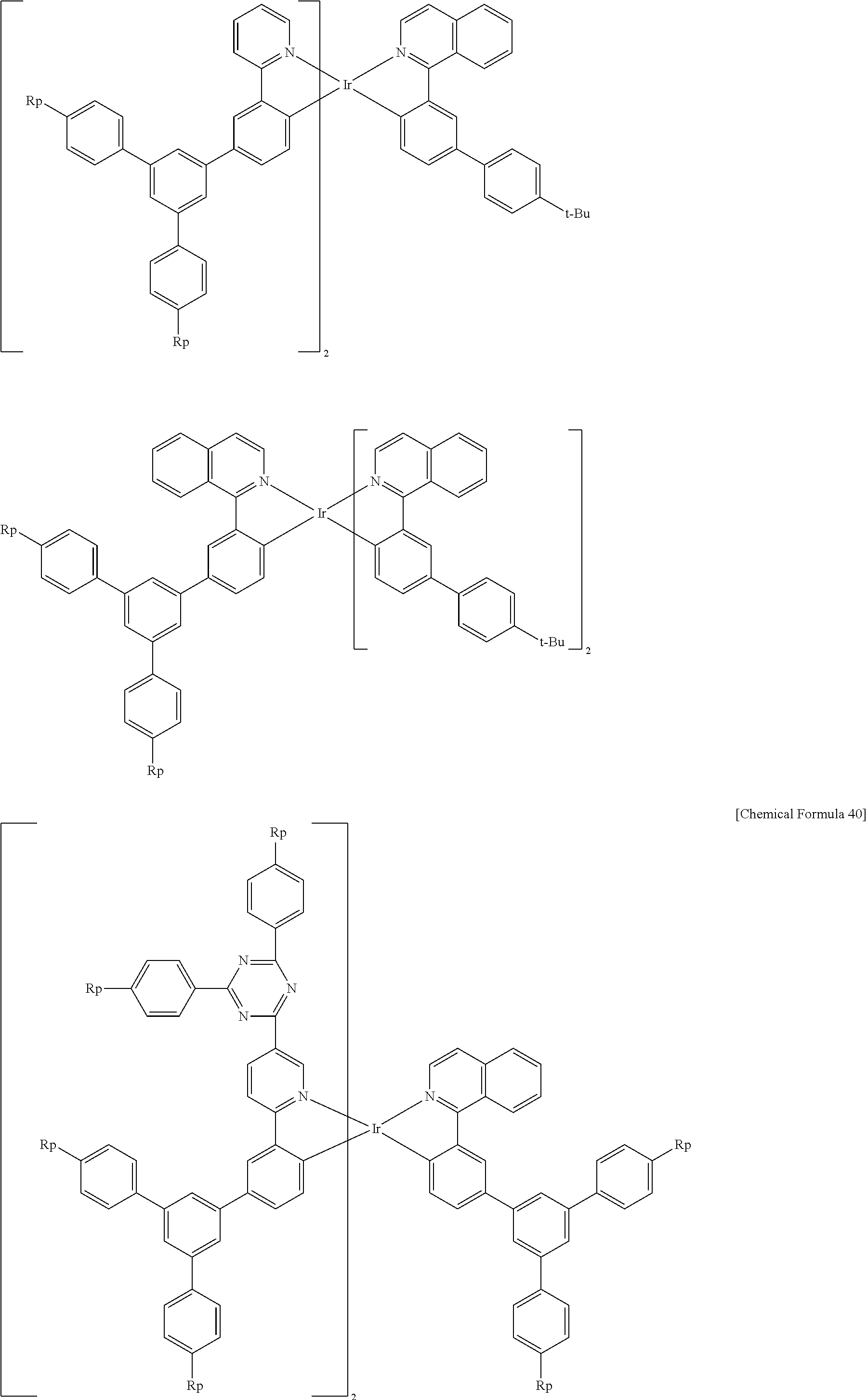

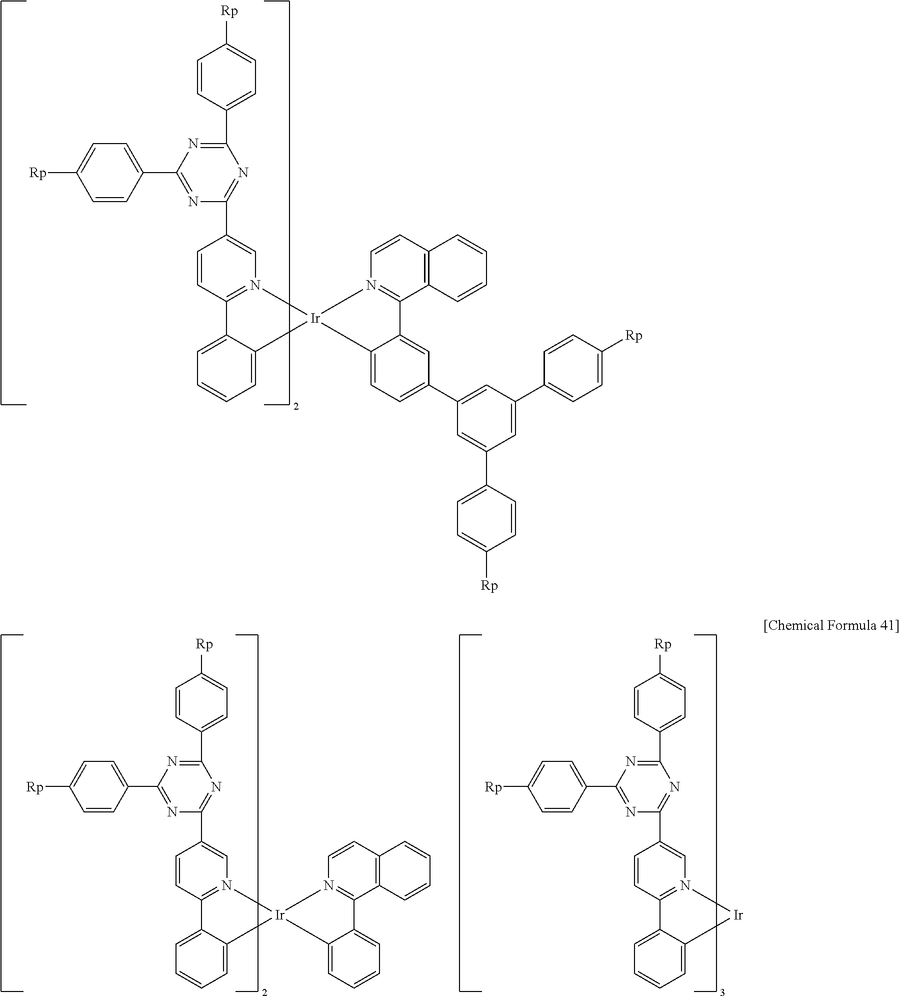

Rp represents a hydrogen atom, a tert-butyl group, an n-hexyl group, or a group represented by formula below.

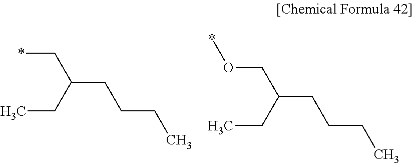

### <Host Material>

By blending further a host material in the composition of the present invention, the external quantum efficiency of the light-emitting device manufactured using the composition of the present invention can be more enhanced.

When the host material is contained in the composition of the present invention, a ratio of the weight of the host material relative to the total weight of the host material, the phosphorescent light-emitting compound (B), the phosphorescent light-emitting compound (G), and the phosphorescent light-emitting compound (R) is usually 0.1 to 0.99 and preferably 0.5 to 0.95.

Because the external quantum efficiency of the light-emitting device obtained from the composition of the present invention can be further enhanced, the minimum triplet excited state (T₁) that the host material has is preferably at an energy level equal to or higher than an energy level at which the minimum triplet excited state (T₁) that the phosphorescent light-emitting compound (B) has is.

Because the durability of the light-emitting device against a process for manufacturing a device such as the light-emitting device and the stability of the light-emitting device against generation of heat (heat resistance) during the drive of the light-emitting device can be enhanced, the host material has a glass transition temperature (Tg) of preferably 70° C. or more and more preferably 100° C. or more.

Because a solution coating process can be used during manufacturing the light-emitting device from the composition of the present invention, the host material exhibits preferably solubility relative to an organic solvent capable of dissolving the composition of the present invention.

As the host material, a publicly known host material can be used and the host materials may be used individually or in combination of two or more types thereof. Examples of the host material include a hole transport material and an electron transport material.

The hole transport material may be a material publicly known as the hole transport material of the organic EL device. Examples of the hole transport material include: polyvinylcarbazole and derivatives thereof; polysilane and derivatives thereof; a polysiloxane derivative having an aromatic amine in side chains or the main chain thereof; a pyrazoline derivative; an arylamine derivative; a stilbene derivative; polyaniline and derivatives thereof; polythiophene and derivatives thereof; polyarylamine and derivatives thereof; polypyrrole and derivatives thereof; poly(p-phenylenevinylene) and derivatives thereof; and poly(2,5-thienylenevinylene) and derivatives thereof. The hole transport material may have one or more types of material selected from the group consisting of an arylene group and a divalent aromatic heterocyclic group as a copolymerization component (constitutional unit).

The electron transport material may be a material publicly known as the electron transport material of the organic EL device. Examples of the electron transport material include an oxadiazole derivative, anthraquinodimethane and derivatives thereof, benzoquinone and derivatives thereof, naphthoquinone and derivatives thereof, anthraquinone and derivatives thereof, tetracyanoanthraquinodimethane and derivatives thereof, a fluorenone derivative, diphenyldicyanoethylene and derivatives thereof, a diphenoquinone derivative, a metal complex of 8-hydroxyquinoline and derivatives thereof, triaryltriazine and derivatives thereof, polyquinoline and derivatives thereof, polyquinoxaline and derivatives thereof, and polyfluorene and derivatives thereof. The electron transport material may have one or more types of material selected from the group consisting of an arylene group and a divalent aromatic heterocyclic group as a copolymerization component (constitutional unit).

The host material is preferably a polymer compound and more preferably a polyvinylcarbazole or derivatives thereof, or a polymer compound (H1) containing a constitutional unit represented by Formula (H-A).

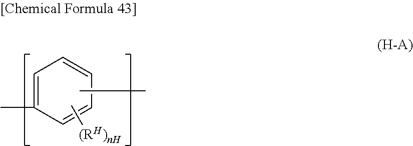

In Formula (H-A), R^{H} represents a substituent and is preferably an alkyl group, a group represented by —O—R^{A}, a group represented by —N(R^{A})₂, an aryl group, or a monovalent aromatic heterocyclic group and more preferably an alkyl group, a group represented by —N(R^{A})₂, an aryl group, or a monovalent aromatic heterocyclic group. When R^{H} is plurally present, R^{H}s may be the same as or different from each other.

The aryl group represented by R^{H} is preferably a monovalent group remaining after removing one hydrogen atom directly bonded to a carbon atom making up a ring from benzene, naphthalene, anthracene, fluorene, spirobifluorene, phenanthrene, dihydrophenanthrene, or pyrene, and these groups may have a substituent. The substituent is preferably an alkyl group, a group represented by —O—R^{A}, a group represented by —N(R^{A})₂, an aryl group, or a monovalent aromatic heterocyclic group, more preferably an alkyl group, a group represented by —O—R^{A}, an aryl group, or a monovalent aromatic heterocyclic group, and further preferably an alkyl group or an aryl group.

The aryl group represented by R^{H} is more preferably aryl groups represented by formulae below and these groups may have further a substituent. In the formulae below, although R^{B} represents the same as defined above, R^{B} is preferably an alkyl group, an aryl group, or a monovalent aromatic heterocyclic group and more preferably an alkyl group or an aryl group.

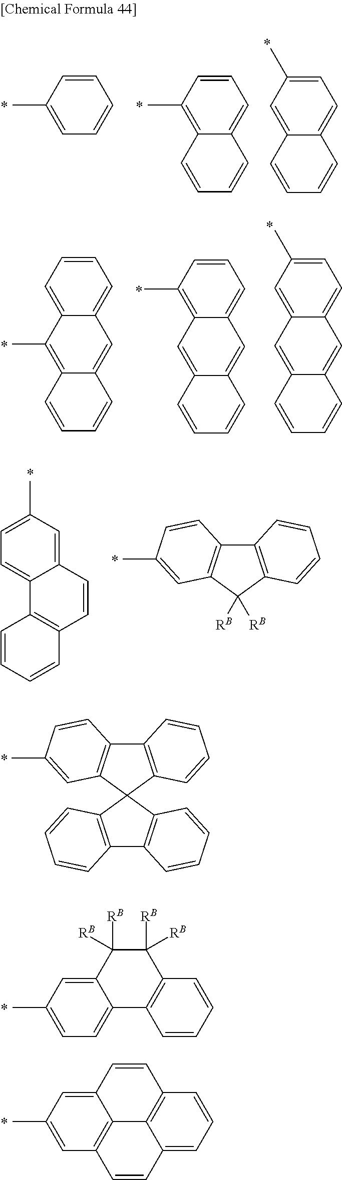

The monovalent aromatic heterocyclic group represented by R^{H} is preferably a monovalent group remaining after removing one hydrogen atom directly bonded to a carbon atom or a hetero atom making up a ring from pyridine, diazabenzene, triazine, quinoline, isoquinoline, pyrrole, carbazole, furan, thiophene, or oxadiazole, and these groups may have a substituent. The substituent is preferably an alkyl group, a group represented by —O—R^{A}, a group represented by —N(R^{A})₂, an aryl group, or a monovalent aromatic heterocyclic group, more preferably an alkyl group, a group represented by —O—R^{A}, an aryl group, or a monovalent aromatic heterocyclic group, and further preferably an alkyl group or an aryl group.

The monovalent aromatic heterocyclic group represented by R^{H} is more preferably monovalent aromatic heterocyclic groups represented by formulae below and these groups may have a substituent. In the formulae below, although R^{A} represents the same as defined above, R^{A} is preferably an alkyl group or an aryl group.

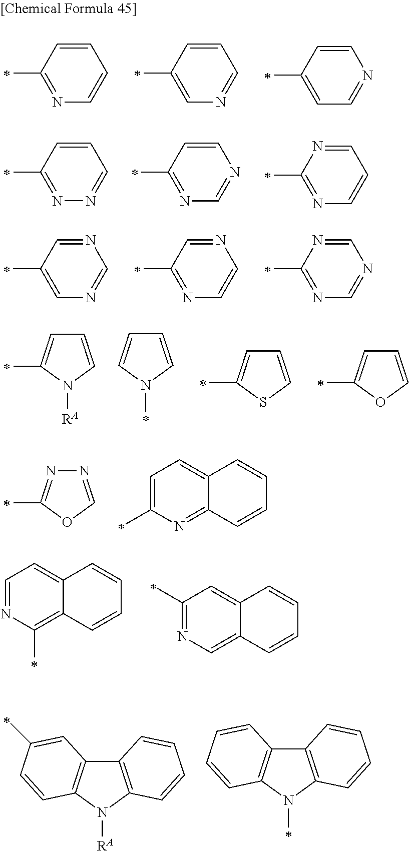

In R^{H}, R^{A} in a group represented by —O—R^{A} is preferably an alkyl group, an aryl group, or a monovalent aromatic heterocyclic group and more preferably an alkyl group or an aryl group.

In R^{H}, although R^{A} in a group represented by —N(R^{A})₂ is the same as defined above, R^{A} is preferably an aryl group or a monovalent aromatic heterocyclic group and more preferably an aryl group.

nH represents an integer of 0 or more and 4 or less and is preferably an integer of 1 or more.

The polymer compound (H1) may contain two or more types of constitutional units represented by Formula (H-A).

The constitutional unit represented by Formula (H-A) is preferably a constitutional unit represented by Formula (H-A1) below or Formula (H-A2) below.

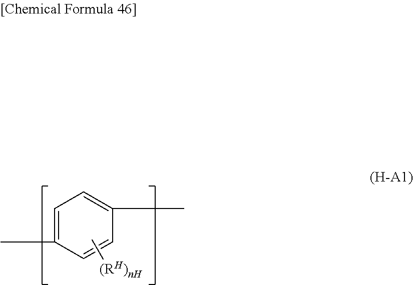

In Formula (H-A1), R^{H} and nH represent the same as defined above.

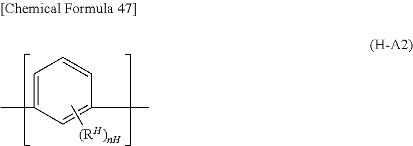

In Formula (H-A2), R^{H} and nH represent the same as defined above.

The constitutional unit represented by Formula (H-A) is preferably also a constitutional unit represented by Formula (H1-A) below.

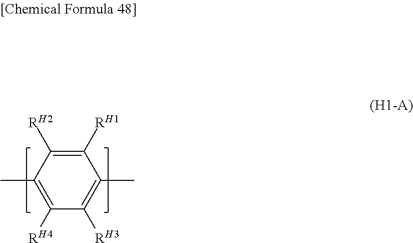

In Formula (H1-A), R^{H1} represents a substituent and is preferably a fluorine atom, an alkyl group, a group represented by —O—R^{A}, a group represented by —N(R^{A})₂, an aryl group, or a monovalent aromatic heterocyclic group, more preferably an alkyl group, a group represented by —O—R^{A}, or an aryl group, and further preferably an alkyl group or an aryl group. The alkyl group may be substituted with a fluorine atom. When R^{H1} is plurally present in the polymer compound (H1), R^{H1}s may be the same as or different from each other.

R^{H2}, R^{H3}, and R^{H4} each independently represent a hydrogen atom or a substituent and are preferably a hydrogen atom, an alkyl group, an aryl group, a monovalent aromatic heterocyclic group, or a fluorine atom, more preferably a hydrogen atom, an alkyl group, or an aryl group, and further preferably a hydrogen atom or an alkyl group. The alkyl group may be substituted with a fluorine atom. When R^{H2} is plurally present in the polymer compound (H1), R^{H2}s may be the same as or different from each other. When R^{H3} is plurally present in the polymer compound (H1), R^{H3}s may be the same as or different from each other. When R^{H4} is plurally present in the polymer compound (H1), R^{H4}s may be the same as or different from each other.

Examples of the constitutional unit represented by Formula (H1-A) include constitutional units represented by Formula (H1-A1) to Formula (H1-A45).

TABLE 6

| FORMULA | R^{H1} | R^{H2} | R^{H3} | R^{H4} |
|---|---|---|---|---|
| (H1-A1) | CH₃ | H | H | CH₃ |
| (H1-A2) | C₂H₅ | H | H | C₂H₅ |
| (H1-A3) | n-C₃H₇ | H | H | n-C₃H₇ |
| (H1-A4) | CH(CH₃)₂ | H | H | CH(CH₃)₂ |
| (H1-A5) | n-C₄H₉ | H | H | n-C₄H₉ |
| (H1-A6) | CH(CH₃)₂(C₂H₅) | H | H | CH(CH₃)(C₂H₅) |
| (H1-A7) | CH₂CH(CH₃)₂ | H | H | CH₂CH(CH₃)₂ |
| (H1-A8) | CH₂CH₂CH(CH₃)₂ | H | H | CH₂CH₂CH(CH₃)₂ |
| (H1-A9) | cyclohexyl | H | H | cyclohexyl |
| (H1-A10) | n-C₆H₁₃ | H | H | n-C₆H₁₃ |
| (H1-A11) | cyclohexylmethyl | H | H | cyclohexylmethyl |
| (H1-A12) | 2-ethylhexyl | H | H | 2-ethylhexyl |
| (H1-A13) | n-C₈H₁₇ | H | H | n-C₈H₁₇ |
| (H1-A14) | 3,7-dimethyloctyl | H | H | 3,7-dimethyloctyl |
| (H1-A15) | CH₃ | H | H | C₂H₅ |
| (H1-A16) | CH₃ | H | H | CH(CH₃)₂ |
| (H1-A17) | n-C₄H₉ | H | H | CH(CH₃)₂ |
| (H1-A18) | CH₃ | CH₃ | CH₃ | CH₃ |
| (H1-A19) | phenyl | H | H | phenyl |
| (H1-A20) | H | H | H | H |
| (H1-A21) | CH₃ | H | H | H |
| (H1-A22) | C₂H₅ | H | H | H |
| (H1-A23) | n-C₃H₇ | H | H | H |
| (H1-A24) | CH(CH₃)₂ | H | H | H |
| (H1-A25) | n-C₄H₉ | H | H | H |
| (H1-A26) | CH(CH₃)(C₂H₅) | H | H | H |
| (H1-A27) | CH₂CH(CH₃)₂ | H | H | H |
| (H1-A28) | CH₂CH₂CH(CH₃)₂ | H | H | H |
| (H1-A29) | cyclohexyl | H | H | H |
| (H1-A30) | n-C₆H₁₃ | H | H | H |
| (H1-A31) | cyclohexylmethyl | H | H | H |
| (H1-A32) | 2-ethylhexyl | H | H | H |
| (H1-A33) | n-C₈H₁₇ | H | H | H |
| (H1-A34) | 3,7-dimethyloctyl | H | H | H |
| (H1-A35) | phenyl | H | H | H |

TABLE 7

| FORMULA | R^{H1} | R^{H2} | R^{H3} | R^{H4} |
|---|---|---|---|---|
| (H1-A36) | CF₃ | H | H | CF₃ |
| (H1-A37) | C₂F₅ | H | H | C₂F₅ |
| (H1-A38) | n-C₃F₇ | H | H | n-C₃F₇ |
| (H1-A39) | n-C₆F₁₃ | H | H | n-C₆F₁₃ |
| (H1-A40) | n-C₈F₁₇ | H | H | n-C₈F₁₇ |
| (H1-A41) | F | H | H | H |
| (H1-A42) | F | H | H | F |
| (H1-A43) | F | F | F | F |
| (H1-A44) | C₂F₅ | H | H | H |
| (H1-A45) | n-C₃F₇ | H | H | H |

The polymer compound (H1) may contain further one or more type(s) of constitutional unit(s) selected from the group consisting of an arylene group, a divalent aromatic heterocyclic group, a hole-transport constitutional unit, and an electron-transport constitutional unit.

The arylene group that the polymer compound (H1) may contain is preferably a divalent group remaining after removing two hydrogen atoms directly bonded to a carbon atom making up a ring from naphthalene, anthracene, fluorene, spirobifluorene, phenanthrene, or dihydrophenanthrene, and these groups may have a substituent. The substituent is preferably an alkyl group, a group represented by —O—R^{A}, a group represented by —N(R^{A})₂, an aryl group, or a monovalent aromatic heterocyclic group, more preferably an alkyl group, a group represented by —O—R^{A}, an aryl group, or a monovalent aromatic heterocyclic group, and further preferably an alkyl group or an aryl group.

The arylene group that the polymer compound (H1) may contain is more preferably arylene groups represented by formulae below and these groups may have a substituent. In the formulae below, although R^{B} represents the same as defined above, R^{B} is preferably an alkyl group, an aryl group, or a monovalent aromatic heterocyclic group and more preferably an alkyl group or an aryl group.

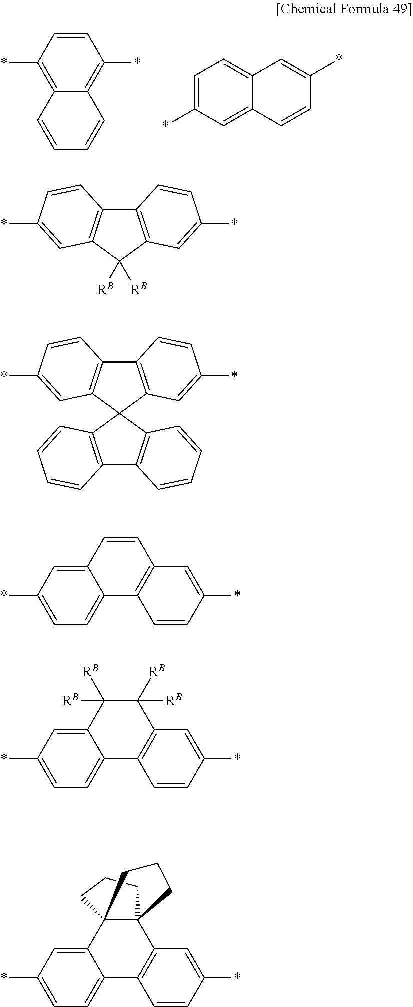

The divalent aromatic heterocyclic group that the polymer compound (H1) may contain is preferably a group remaining after removing two hydrogen atoms directly bonded to a carbon atom or a hetero atom making up a ring from pyridine, diazabenzene, triazine, quinoline, isoquinoline, carbazole, dibenzofuran, dibenzothiophene, phenoxazine, phenothiazine, benzothiadiazole, or oxadiazole, and these groups may have a substituent. The substituent is preferably an alkyl group, a group represented by —O—R^{A}, a group represented by —N(R^{A})₂, an aryl group, or a monovalent aromatic heterocyclic group, more preferably an alkyl group, a group represented by —O—R^{A}, an aryl group, or a monovalent aromatic heterocyclic group, and further preferably an alkyl group or an aryl group.

The divalent aromatic heterocyclic group that the polymer compound (H1) may contain is more preferably divalent aromatic heterocyclic groups represented by formulae below and these groups may have a substituent. In the formulae below, although R^{A} represents the same as defined above, R^{A} is preferably an alkyl group or an aryl group.

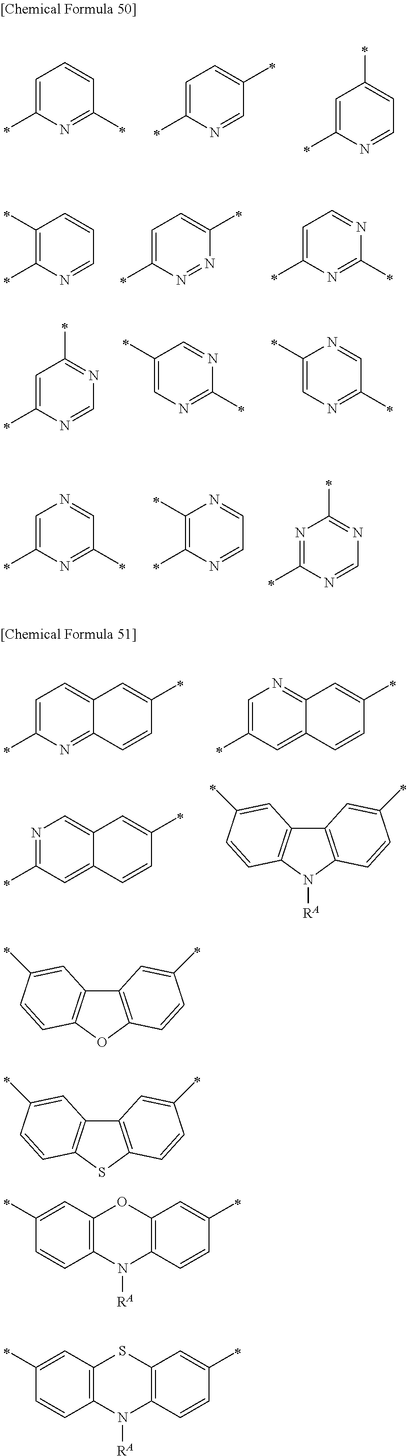

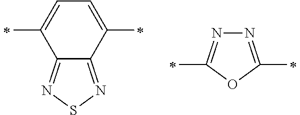

As the hole-transport constitutional unit, a publicly known hole-transport constitutional unit can be used. Examples of the hole-transport constitutional unit include constitutional units containing the compounds exemplified above as the hole-transport material as a partial structure and among them, a constitutional unit containing a triarylamine skeleton as a partial structure is preferred.

The hole-transport constitutional unit is more preferably constitutional units represented by Formula (H-H1):

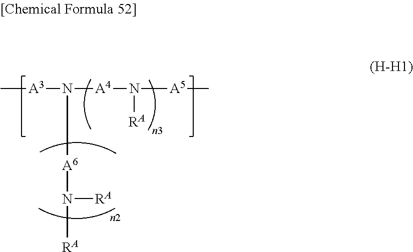

In Formula (H-H1), n2 represents an integer of 0 or more and is preferably 3 or less and more preferably 0. n3 represents an integer of 0 or more and is preferably 2 or less and more preferably 1.

In Formula (H-H1), A³ and A⁵ each independently represent an arylene group or a divalent aromatic heterocyclic group.

The arylene group represented by A³ or A⁵ is preferably a divalent group remaining after removing two hydrogen atoms directly bonded to a carbon atom making up a ring from benzene, naphthalene, anthracene, fluorene, spirobifluorene, phenanthrene, dihydrophenanthrene, or pyrene. These divalent groups may have a substituent. The substituent is preferably an alkyl group, a group represented by —O—R^{A}, a group represented by —N(R^{A})₂, an aryl group, or a monovalent aromatic heterocyclic group, more preferably an alkyl group, a group represented by —O—R^{A}, an aryl group, or a monovalent aromatic heterocyclic group, and further preferably an alkyl group or an aryl group. R^{A} represents the same as defined above.

The arylene group represented by A³ or A⁵ is more preferably arylene groups represented by formulae below and these groups may have a substituent. In the formulae below, although R^{B} represents the same as defined above, R^{B} is preferably an alkyl group, an aryl group, or a monovalent aromatic heterocyclic group and more preferably an alkyl group or an aryl group.

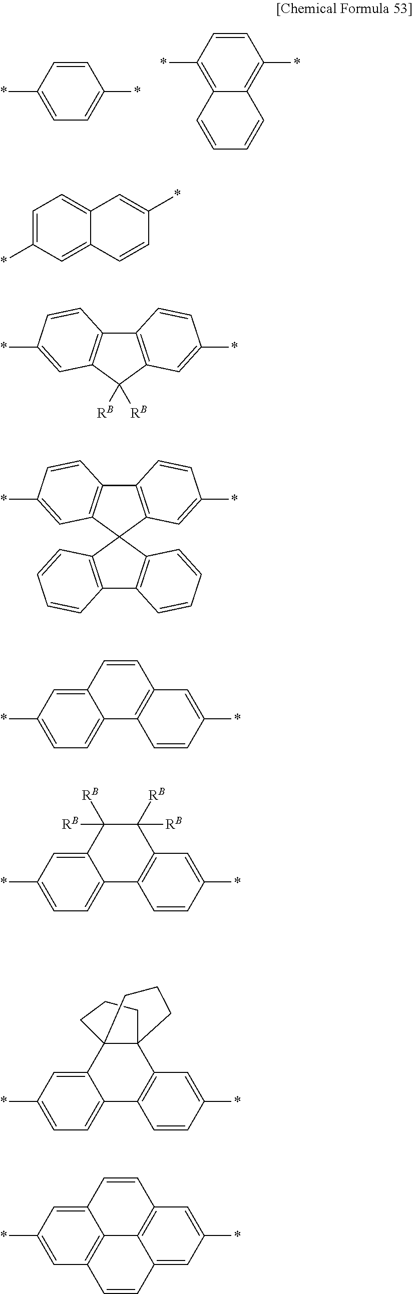

The definition and examples of the divalent aromatic heterocyclic group represented by A³ or A⁵ are the same as the definition and examples of the divalent aromatic heterocyclic group that the polymer compound (H1) may contain.

In Formula (H-H1), A⁴ and A⁶ represent an arylene group, a divalent aromatic heterocyclic group, or a divalent group in which two or more groups selected from the group consisting of an arylene group and a divalent aromatic heterocyclic group are directly bonded with each other and these groups may have a substituent. When A⁴ is plurally present, A⁴s may be the same as or different from each other. When A⁶ is plurally present, A^{b}s may be the same as or different from each other.

The definition and examples of the arylene group represented by A⁴ or A⁶ are the same as the definition and examples of the above arylene group represented by A³ or A⁵. The definition and examples of the divalent aromatic heterocyclic group represented by A⁴ or A⁶ are the same as the definition and examples of the above divalent aromatic heterocyclic group represented by A³ or A⁵.

In the divalent group represented by A⁴ or A⁶ in which two or more groups selected from the group consisting of an arylene group and a divalent aromatic heterocyclic group are directly bonded with each other, the definition and examples of the arylene group are the same as the definition and examples of the above arylene group represented by A³ or A⁵. In the divalent group represented by A⁴ or A⁶ in which two or more groups selected from the group consisting of an arylene group and a divalent aromatic heterocyclic group are directly bonded with each other, the definition and examples of the divalent aromatic heterocyclic group are the same as the definition and examples of the above divalent aromatic heterocyclic group represented by A³ or A⁵.

Examples of the divalent group represented by A⁴ or A⁶ in which two or more groups selected from the group consisting of an arylene group and a divalent aromatic heterocyclic group are directly bonded with each other include structures represented by formulae below and these groups may have a substituent.

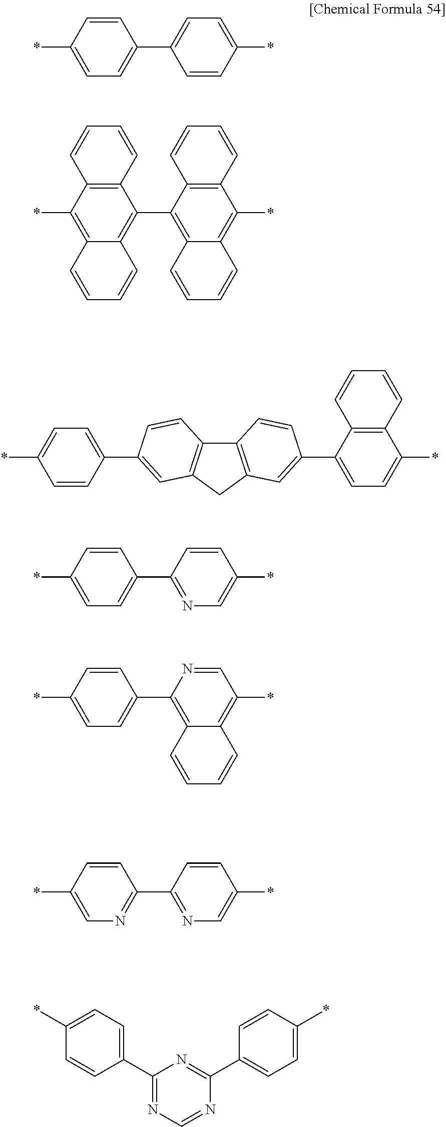

In Formula (H-H1), although R^{A} represents the same as defined above, R^{A} is preferably an aryl group or a monovalent aromatic heterocyclic group and more preferably an aryl group. When R^{A} is plurally present, R^{A}s may be the same as or different from each other.

Examples of the constitutional unit represented by Formula (H-H1) include structures below, and these groups may have a substituent. In the formulae below, although R^{B} represents the same as defined above, R^{B} is preferably an alkyl group, an aryl group, or a monovalent aromatic heterocyclic group and more preferably an alkyl group or an aryl group.

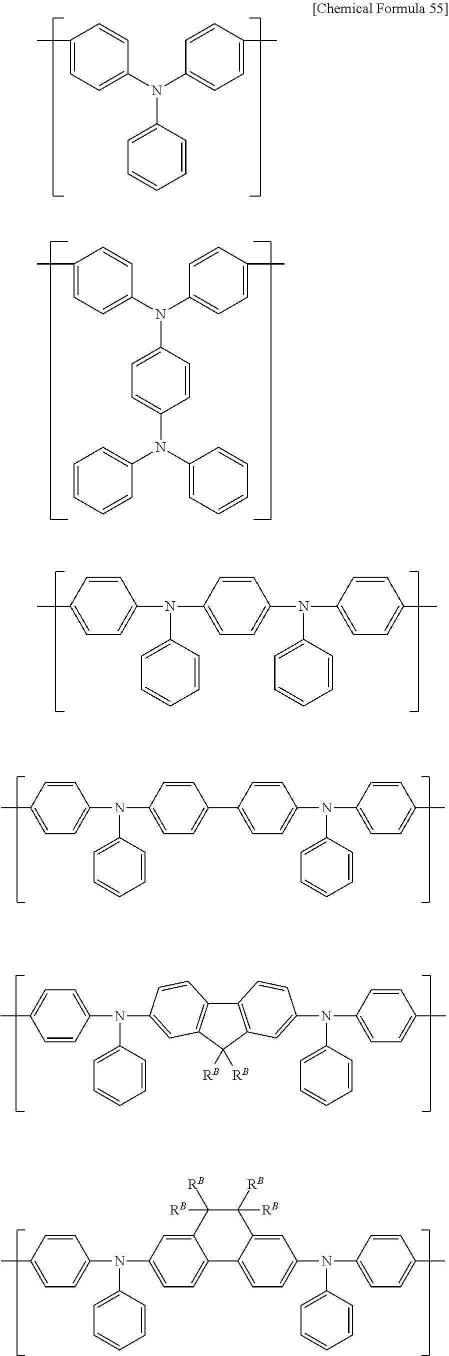

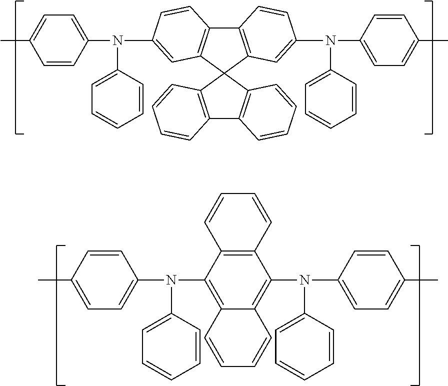

As the electron-transport constitutional unit, a publicly known electron-transport constitutional unit can be used. Examples of the electron-transport constitutional unit include constitutional units containing the compounds exemplified above as the electron-transport material as a partial structure and the electron-transport constitutional unit is preferably a constitutional unit containing a triaryltriazine skeleton as a partial structure and more preferably a constitutional unit containing a 2,4,6-triaryl-1,3,5-triazine skeleton as a partial structure. Examples of the constitutional unit include a constitutional unit represented by formula below. The constitutional unit may have a substituent.

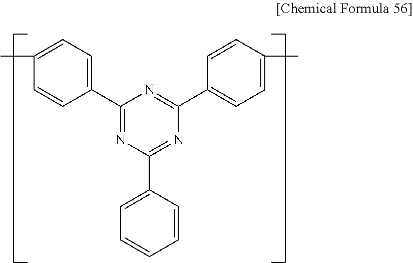

The polymer compound (H1) contains a constitutional unit represented by Formula (H-A) in a content of preferably 10% by mol or more, more preferably 30% by mol or more, further preferably 50% by mol or more, and particularly preferably 80% by mol or more.

When a terminal group of the polymer compound (H1) is a polymerization-active group, in the case where the composition is used for manufacturing the light-emitting device, there is a probability that the light-emitting characteristics of the obtained light-emitting device lowers. Therefore, a terminal group of the polymer compound (H1) is preferably a stable group. The terminal group is preferably conjugated-bonded with the main chain. Examples of such a group include a group bonded to an aryl group or a monovalent aromatic heterocyclic group through a carbon-carbon bond.

<Other Components>

The composition of the invention may include a light-emitting material other than the phosphorescent light-emitting compound (B), the phosphorescent light-emitting compound (G), and the phosphorescent light-emitting compound (R). Examples of the phosphorescent materials include a fluorescent light-emitting compound. The fluorescent light-emitting compound includes a low molecular fluorescent material and a polymer fluorescent material. The low molecular fluorescent material is usually a material having a maximum peak of fluorescent light emission at a wavelength in a range of 400 nm to 700 nm and having a molecular weight of usually less than 3,000, preferably 100 to 2,000, and more preferably 100 to 1,000.

The low molecular fluorescent material may be a material publicly known as the light-emitting material of the organic EL device. Examples of the low molecular fluorescent material include: a dye-based material such as a naphthalene derivative, anthracene and derivatives thereof, perylene and derivatives thereof, a quinacridone derivative, a xanthene-based dye, a coumarin-based dye, a cyanine-based dye, a triphenylamine derivative, an oxadiazole derivative, a pyrazoloquinoline derivative, a distyrylbenzene derivative, a distyrylarylene derivative, a pyrrole derivative, a thiophene ring compound, a pyridine ring compound, and an oligothiophene derivative; and a metal complex material such as a metal complex having as a central metal atom, Al, Zn, Be, or the like, or a rare earth metal atom such as Tb, Eu, and Dy and having as a ligand, an oxadiazole, thiadiazole, phenylpyridine, phenylbenzoimidazole, quinoline structure, or the like, the metal complex such as an aluminum-quinolinol complex, a benzoquinolinol-beryllium complex, a benzoxazolyl-zinc complex, a benzothiazole-zinc complex, an azomethyl-zinc complex, a porphyrin-zinc complex, an europium complex.

Examples of the polymer fluorescent material include a poly-para-phenylenevinylene derivative, a polythiophene derivative, a poly-para-phenylene derivative, a polysilane derivative, a polyacetylene derivative, a polyfluorene derivative, a polyvinylcarbazole derivative, and a plastid containing a dye-based material exemplified above in examples of the low molecular fluorescent material.

In the composition of the present invention, the light-emitting material other than the phosphorescent light-emitting compound (B), the phosphorescent light-emitting compound (G), and the phosphorescent light-emitting compound (R) may be used individually or in combination of two or more types thereof.

<Liquid Composition>

The liquid composition of the present invention contains the composition of the present invention and a solvent. The liquid composition of the present invention is useful for a printing method and the like and may be generally called an ink, an ink composition, or the like. The solvent used for the liquid composition of the present invention may contain if necessary, a component such as a stabilizer, a thickener (a polymer compound for enhancing the viscosity), low and high molecular compounds for lowering the viscosity, a surfactant, an antioxidant, and the like. The compounds of each component contained in the liquid composition of the present invention may be used individually or in combination of two or more types thereof.

The ratio of the composition of the present invention in the liquid composition of the present invention when the whole liquid composition is assumed to be 100 parts by weight is usually 0.1 parts by weight to 99 parts by weight, preferably 0.5 parts by weight to 40 parts by weight, and more preferably 0.5 parts by weight to 20 parts by weight.

The viscosity of the liquid composition of the present invention may be controlled depending on the printing method to which the liquid composition of the present invention is applied. When the printing method is a printing method in which the liquid composition is flowed through a discharge apparatus such as an inkjet printing method, in order to prevent a clogging and a flying warp during the discharge, the viscosity of the liquid composition at 25° C. is preferably in a range of 1 mPa·s to 20 mPa·s.

The thickener may be a thickener soluble in a solvent used for the liquid composition of the present invention and not hindering light emission or charge transport. As the thickener, a compound such as polymer polystyrene and polymer polymethyl methacrylate can be used. The thickener has a polystyrene-equivalent weight average molecular weight of preferably 5×10⁵ or more, and more preferably 1×10⁶ or more.

The antioxidant is used for enhancing the preservation stability of the liquid composition. The antioxidant may be any antioxidant so long as the antioxidant is soluble in the same solvent as the solvent for the composition of the present invention and does not hinder light emission or charge transport. Examples of the antioxidant include a phenol-based antioxidant and a phosphorus-based antioxidant.

The solvent making up the liquid composition of the present invention is preferably a solvent capable of dissolving a solid content as the solute or a solvent capable of homogeneously dispersing the solid content. Examples of the solvent include: a chlorinated solvent such as chloroform, methylene chloride, 1,2-dichloroethane, 1,1,2-trichloroethane, chlorobenzene, and o-dichlorobenzene; an ether solvent such as tetrahydrofuran, dioxane, and anisole; an aromatic hydrocarbon solvent such as toluene and xylene; an aliphatic hydrocarbon solvent such as cyclohexane, methylcyclohexane, n-pentane, n-hexane, n-heptane, n-octane, n-nonane, and n-decane; a ketone solvent such as acetone, methyl ethyl ketone, cyclohexanone, benzophenone, and acetophenone; an ester solvent such as ethyl acetate, butyl acetate, ethylcellosolve acetate, methyl benzoate, and phenyl acetate; a polyhydric alcohol and derivatives thereof such as ethylene glycol, ethylene glycol monobutyl ether, ethylene glycol monoethyl ether, ethylene glycol monomethyl ether, dimethoxyethane, propylene glycol, diethoxymethane, triethylene glycol monoethyl ether, glycerin, and 1,2-hexanediol, an alcohol solvent such as methanol, ethanol, propanol, isopropanol, and cyclohexanol; a sulfoxide solvent such as dimethylsulfoxide, and an amide solvent such as N-methyl-2-pyrrolidone and N,N-dimethylformamide.

These solvents may be used individually or in combination of two or more types thereof. Because the film formation property of the liquid composition and the element characteristics of the light-emitting element obtained from the liquid composition can be enhanced, these solvents may be used preferably in combination of two or more types thereof, more preferably in combination of two or three types thereof, and particularly preferably in combination of two types thereof.

When two types of solvents are contained in the liquid composition of the present invention, one type of solvent among them may be a solvent in a solid state at 25° C. Because the film formation property of the liquid composition can be enhanced, one type of solvent among them is preferably a solvent having a boiling point of 180° C. or more, and more preferably a solvent having a boiling point of 200° C. or more. Because the liquid composition can have an appropriate viscosity, the composition of the present invention is preferably dissolved in both of the two types of solvents in a concentration of 1% by weight or more at 60° C. and the composition of the present invention is more preferably dissolved in one type of solvent among the two types of solvents in a concentration of 1% by weight or more at 25° C.

When two or more types of solvents are contained in the liquid composition of the present invention, because the liquid composition can have an appropriate viscosity and excellent film formation property, a ratio of a solvent having the highest boiling point based on the weight of all solvents in the liquid composition is preferably 40 to 90% by weight, more preferably 50 to 90% by weight, and further preferably 65 to 85% by weight.

The liquid composition of the present invention may further contain water, silicon, boron, phosphorus, fluorine, chlorine, bromine, metals and salts thereof, and the like in a concentration in a range of 1 to 1,000 ppm on a weight basis. Examples of the metal include lithium, sodium, calcium, potassium, iron, copper, nickel, aluminum, zinc, chromium, manganese, cobalt, platinum, iridium, and palladium.

<Film>

The film of the present invention contains the composition of the present invention. Examples of the film of the present invention include a light-emitting film, a conductive film, and an organic semiconductor film.

The film of the present invention can be prepared with the composition of the present invention by a method such as a spin coating method, a casting method, a micro gravure coating method, a gravure printing method, a bar coating method, a roll coating method, a wire bar coating method, a dip coating method, a spray coating method, a screen printing method, a flexo printing method, an offset printing method, an inkjet printing method, a capillary coating method, and a nozzle coating method.

The film of the present invention has a thickness of usually 1 nm to 10 μm.

<Light-Emitting Device>

The light-emitting device of the present invention has the electrode consisting of an anode and a cathode, and a layer containing the composition of the present invention provided between the electrodes.

The layer containing the composition of the present invention is preferably one or more type(s) of layer(s) of a light-emitting layer, a hole transport layer, a hole injection layer, an electron transport layer, and an electron injection layer and more preferably a light-emitting layer. Each layer of these layers contains individually a light-emitting material, a hole transport material, a hole injection material, an electron transport material, and an electron injection material. When each layer is formed, a light-emitting material, a hole transport material, a hole injection material, an electron transport material, and an electron injection material can be individually dissolved in the above-described solvent to prepare the composition of the present invention to be used. When each layer is formed, the same method as the above-described method for preparing the film of the present invention can be used. The hole transport layer may be called an interlayer layer.

The light-emitting device has at least one light-emitting layer between the anode and the cathode. The light-emitting device of the present invention has preferably, for enhancing hole injection property and hole transportability, at least one layer of the hole injection layer and the hole transport layer between the anode and the light-emitting layer and/or at least one layer of the electron injection layer and the electron transport layer between the cathode and the light-emitting layer.

When the light-emitting device has a hole transport layer, examples of the material for the hole transport layer include the above-described hole transport materials. When the hole transport material is dissolved in a solvent used for forming a layer (usually a light-emitting layer) adjacent to the hole transport layer in the manufacturing of the light-emitting device, for preventing the hole transport material from being dissolved in the solvent, the hole transport material has preferably a crosslinkable group. After making the hole transport layer to a film using a hole transport material having a crosslinkable group and by crosslinking the crosslinkable group contained in the hole transport material intramolecularly or intermolecularly using heat, light, or the like, the hole transport material can be insolubilized.

When the light-emitting device has an electron transport layer, examples of the material for the electron transport layer include the above-described electron transport materials. When the electron transport material is dissolved in a solvent used for forming a layer (usually a light-emitting layer) adjacent to the electron transport layer in the manufacturing of the light-emitting device, for preventing the electron transport material from being dissolved in the solvent, the electron transport material has preferably a crosslinkable group. After making the electron transport layer to a film using an electron transport material having a crosslinkable group and by crosslinking the crosslinkable group contained in the electron transport material intramolecularly or intermolecularly using heat, light, or the like, the electron transport material can be insolubilized.

In the light-emitting device of the present invention, examples of the forming method of the hole transport layer and the electron transport layer when a low molecular weight compound is used include a vacuum deposition method from a powder and a method by film formation from a solution or a molten state. When a polymer compound is used, examples thereof include a method by film formation from a solution or a molten state.

When the light-emitting device has the hole injection layer and/or the electron injection layer, examples of the material for the hole injection layer and the electron injection layer include hole injection materials and electron injection materials respectively.

Examples of the hole injection material and the electron injection material include one or more type(s) of material(s) selected from the group consisting of low molecular compounds and polymer compounds. Examples of the polymer compound used for the hole injection material and the electron injection material include conductive polymers such as polyaniline and derivatives thereof, polythiophene and derivatives thereof, polypyrrole and derivatives thereof, polyphenylenevinylene and derivatives thereof, polythienylenevinylene and derivatives thereof, polyquinoline and derivatives thereof, polyquinoxaline and derivatives thereof, and polymers containing an aromatic amine structure in the main chain or side chains thereof. Examples of the low molecular compound used for the hole injection material and the electron injection material include a metal phthalocyanine such as copper phthalocyanine, carbon, an oxide of a metal such as molybdenum and tungsten, and a metal fluoride such as lithium fluoride, sodium fluoride, and cesium fluoride.

When the hole injection material and/or the electron injection material contains a conductive polymer, the conductive polymer has an electric conductivity of preferably 1×10⁵ S/cm to 1×10³ S/cm. For causing the electric conductivity of the conductive polymer to fall within such a range, an appropriate amount of ions can be doped in the conductive polymer.

The type of the doped ion is an anion for the hole injection material and a cation for the electron injection material. Examples of the anion include a polystyrenesulfonic acid ion, an alkylbenzenesulfonic acid ion, and a camphorsulfonic acid ion. Examples of the cation include a lithium ion, a sodium ion, a potassium ion, and a tetrabutylammonium ion.

The order and the number of layers to be layered and the thickness of each layer may be controlled by taking into consideration the external quantum efficiency and the device life of the light-emitting device of the invention.

The substrate in the light-emitting device may be a substrate on which an electrode can be formed and which is chemically not changed when an organic layer is formed thereon. Examples of the substrate include substrates composed of materials such as a glass, a plastic, a polymer film, and a silicon. When the substrate is opaque, an electrode positioned opposite to the substrate is preferably transparent or translucent.

Examples of the material for the anode include a conductive metal oxide and a translucent metal, and the material is preferably indium oxide, zinc oxide, or tin oxide; a conductive compound containing a complex combining two or more types selected from indium oxide, zinc oxide, and tin oxide such as indium-tin-oxide (ITO) and indium-zinc-oxide; NESA; gold; platinum; silver; or copper and more preferably ITO, indium-zinc-oxide, or tin oxide.

The anode may be of a layered structure of two or more layers.

As the material for the cathode, a material having a small work function is preferred. Examples of such a material include: a metal such as lithium, sodium, potassium, rubidium, cesium, beryllium, magnesium, calcium, strontium, barium, aluminum, zinc, and indium; an alloy of two or more types of these metals; an alloy of one or more types of these metals with one or more types of silver, copper, manganese, titanium, cobalt, nickel, tungsten, and tin; and graphite and a graphite interlayer compound. Examples of the alloy include a magnesium-silver alloy, a magnesium-indium alloy, a magnesium-aluminum alloy, an indium-silver alloy, a lithium-aluminum alloy, a lithium-magnesium alloy, a lithium-indium alloy, and a calcium-aluminum alloy.

The cathode may be of a layered structure of two or more layers.

For obtaining a surface light emission using the light-emitting device, a planar anode and a planar cathode may be arranged as overlapped on each other. Examples of the method for obtaining a pattern-shaped light emission include: a method for placing a mask in which a pattern-shaped window is provided on the surface of a planar light-emitting device; a method for forming a layer for a non-light-emitting part in an extremely large thickness to make the non-light-emitting part substantially non-light-emitting; and a method for forming any one of or both of the anode and the cathode in a pattern shape. By forming a pattern by any one method among these methods and by arranging several electrodes so that they can be independently subjected to ON/OFF, a segment-type display device capable of displaying a numeral, a letter, a simple symbol, or the like can be obtained. Furthermore, in order to prepare a dot matrix display device, both the anode and the cathode may be formed in a stripe shape so that they cross each other at right angles. By a method for painting the polymer compounds in a plurality of different emitting light colors or by a method for using a color filter or a fluorescence converting filter, a partial color display and a multi-color display become possible. The dot matrix display device can be passive-driven and may be active-driven in combination with TFT or the like. The above-described display device can be used for a computer, a television, a portable terminal, a portable telephone, a car navigation system, a viewfinder for a video camera, and the like. The planar light-emitting device is a selfluminous thin-type surface light source and can be preferably used as a surface light source for a backlight of a liquid crystal display device, or a light source for a planar illumination. The light-emitting device including a flexible substrate can also be used as a curved-face light source and display device.

### EXAMPLES

For describing the present invention more in detail, examples will now be given; however, the present invention is not limited to these examples.

The number average molecular weight (Mn) and the weight average molecular weight (Mw) were measured by size exclusion chromatography (SEC) as the polystyrene-equivalent number average molecular weight (Mn) and the polystyrene-equivalent weight average molecular weight (Mw). Among SEC, a chromatography in which the mobile phase is an organic solvent refers to gel permeation chromatography (GPC). As analysis conditions for GPC, methods illustrated in the analysis condition below were used.

[Analysis Conditions]

The measurement sample was dissolved in tetrahydrofuran in a concentration of about 0.05% by weight and 10 μL of the resultant sample solution was injected into GPC (manufactured by Shimadzu Corporation; trade name: LC-10Avp). As the mobile phase of GPC, tetrahydrofuran was flowed at a flow rate of 2.0 mL/min. As the column, PLgel MIXED-B (manufactured by Polymer Laboratories Ltd.) was used. As the detector, UV-VIS detector (manufactured by Shimadzu Corporation; trade name: SPD-10Avp) was used.

The LC-MS measurement was performed by the method below. The measurement sample was dissolved in chloroform or tetrahydrofuran so that the concentration of the sample became about 2 mg/mL and 1 μL of the resultant sample solution was injected into LC-MS (manufactured by Agilent Technologies, Inc.; trade name: 1100LCMSD). As the mobile phase for LC-MS, ion-exchanged water, acetonitrile, tetrahydrofuran, and a solvent mixture thereof were used and if necessary, acetic acid was added thereto. As the column, L-column 2 ODS (3 μm) (manufactured by Chemicals Evaluation and Research Institute, Japan; inner diameter: 2.1 mm, length: 100 mm, particle diameter: 3 μm) was used.

The TLC-MS measurement was performed by the method below. The measurement sample was dissolved in chloroform or tetrahydrofuran and a small amount of the resultant sample solution was applied onto the surface of a TLC glass plate (Merck & Co., Inc.; trade name: Silica gel 60 F₂₅₄) that was cut beforehand. The resultant sample was measured by TLC-MS (manufactured by JEOL Ltd.; trade name: JMS-T100TD) using a helium gas heated to 240 to 350° C.

The NMR measurement was performed, unless defined otherwise, by a method including: dissolving 5 to 20 mg of the measurement sample in about 0.5 mL of deuterated chloroform; and using NMR (manufactured by Varian, Inc.; trade name: MERCURY 300).

The light-emitting spectrum peak was determined by a method including: dissolving the measuring sample in xylene in a concentration of about 0.8×10⁻⁴% by weight; and measuring the maximum light-emitting wavelength of the resultant solution at room temperature using a fluorospectrophotometer (FP-6500) (manufactured by JASCO Corporation).

### Synthesis Example 1

### Synthesis of Compound M-1

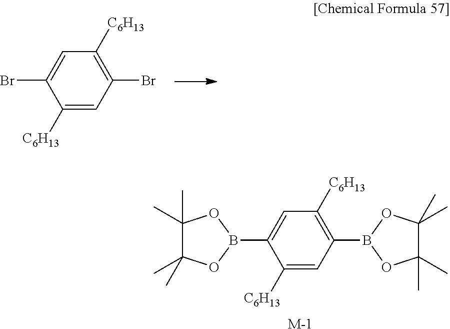

Into a four-neck flask, 8.08 g of 1,4-dihexyl-2,5-dibromobenzene, 12.19 g of bis(pinacolate)diboron, and 11.78 g of potassium acetate were charged and a gas inside the flask was purged with an argon gas. Thereto, 100 mL of dehydrated 1,4-dioxane was charged and the inside of the flask was deaerated with an argon gas. Thereto, 0.98 g of [1,1′-bis(diphenylphosphino)ferrocene]dichloropalladium (II) (Pd(dppf)₂Cl₂) was charged and further, the inside of the flask was deaerated with argon. The resultant reaction solution was heated-refluxed for 6 hours. To the reaction solution, toluene was added and the resultant reaction solution was washed with ion-exchanged water. To the washed organic phase, sodium sulfate anhydride and an activated carbon were added and the resultant organic phase was filtered by a funnel pre-coated with celite. The resultant filtrate was concentrated to obtain 11.94 g of a dark brown crystal. This crystal was recrystallized in n-hexane and the resultant crystal was washed with methanol. The crystal was dried under reduced pressure, thus obtaining 4.23 g of a white capillary crystal of a compound M-1. The yield was 42%.

The results of the ¹H-NMR analysis and the LC-MS analysis of the compound M-1 are illustrated below.

¹H-NMR (300 MHz, CDCl₃): δ (ppm)=0.88 (t, 6H), 1.23-1.40 (m, 36H), 1.47-1.56 (m, 4H), 2.81 (t, 4H), 7.52 (s, 2H) LC-MS (ESI, positive) m/z⁺=573 [M+K]⁺

### Synthesis Example 2

### Synthesis of Compound M-3

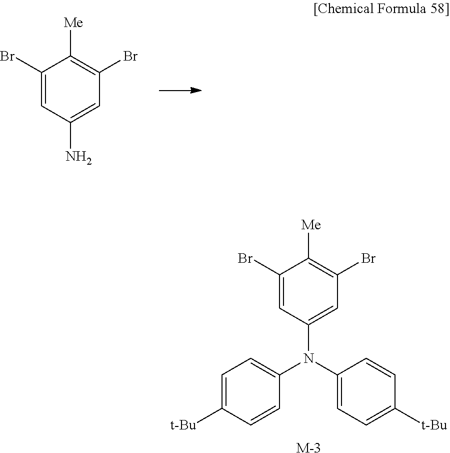

In an argon gas atmosphere, in a flask equipped with a Dean-Stark dehydrator, 3,5-dibromo-4-methylaniline (5.30 g, 20.0 mmol), copper (I) chloride (0.99 g, 10 mmol), 1,10-phenanthroline (1.80 g, 10 mmol), potassium hydroxide (8.98 g, 160 mmol), 4-tert-butyliodobenzene (16.1 g, 62 mmol), and dehydrated toluene (40 mL) were mixed and while heating the resultant reaction solution on an oil bath of 130° C., the reaction solution was refluxed while stirring the reaction solution maintained at the temperature for about 8 hours to dehydrate the reaction solution. The reaction solution was diluted with toluene and the resultant reaction solution was cooled down to room temperature. The reaction solution was passed through a celite pre-coated filter to filter off insoluble matters. To the filtrate, an activated white clay (manufactured by Wako Pure Chemical Industries, Ltd.) was added and the resultant reaction solution was stirred at room temperature for 1 hour to filter off a deposited solid. The above operation of filtering was repeated for three times. Then, the filtrate was concentrated, followed by adding hexane to the concentrate to deposit and filter a solid. The resultant solid was recrystallized in a solvent mixture of toluene-methanol, was further recrystallized in a solvent mixture of toluene-ethanol. Thereafter, the resultant solid was purified by medium pressure silica gel column chromatography (hexane). Then, the solid was recrystallized again in a solvent mixture of toluene-methanol, thus obtaining an objective compound M-3 (5.70 g, HPLC area percentage (ultraviolet ray wavelength: 254 nm)>99.9%, yield: 54%) as a white crystal.

The result of the ¹H-NMR analysis of the compound M-3 is illustrated below.

¹H-NMR (300 MHz, THF-d₈): δ (ppm)=1.33 (s, 18H), 2.49 (s, 3H), 7.01 (d, 4H), 7.16 (s, 2H), 7.36 (d, 4H)

### Synthesis Example 3

### Synthesis of Compound M-4

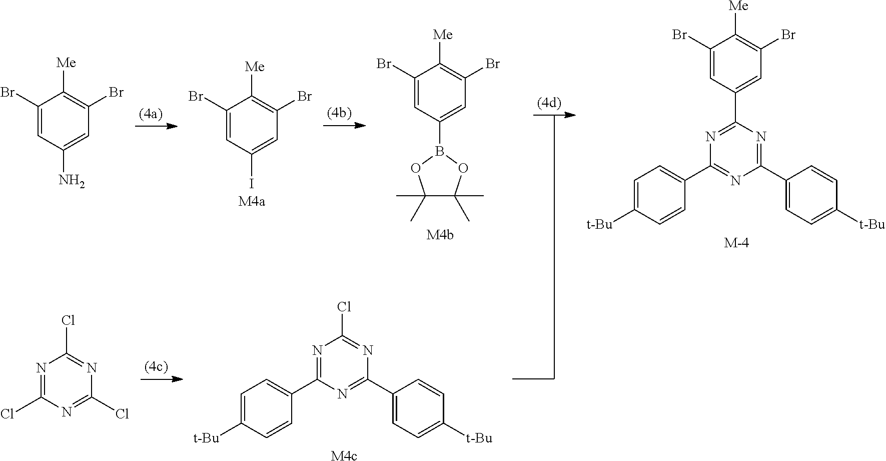

(Step (4a))

In an argon gas atmosphere, in a flask, 3,5-dibromo-4-methylaniline (47.0 g, 177 mmol), 35% by weight hydrochloric acid (111 mL), and ion-exchanged water (111 mL) were mixed and the resultant reaction solution was cooled down in an ice bath. Into the reaction solution mixture, a solution in which sodium nitrite (12.9 g, 186 mmol) was dissolved in ion-exchanged water (about 130 mL) was dropped over about 30 minutes. After the completion of dropping, the reaction solution was stirred at room temperature for about 1 hour and was cooled down in an ice bath again and into the reaction solution, a solution in which potassium iodide (30.9 g, 186 mmol) was dissolved in ion-exchanged water (about 130 mL) was dropped over about 30 minutes. After the completion of dropping, the reaction solution was stirred at room temperature for about 3 hours and while stirring the reaction solution, the reaction solution was slowly added to a separately prepared 10% by weight sodium hydrogen carbonate aqueous solution (about 1,200 mL). The reaction solution was extracted by adding ethyl acetate thereto and the organic phase was washed with a 10% by weight sodium sulfite aqueous solution, was dried over magnesium sulfate anhydride, and was filtered and the filtrate was concentrated to obtain a crude product (77 g). The crude product was dissolved in acetone and to the resultant solution, an activated carbon was added. The resultant reaction solution was stirred and then, filtered and the filtrate was concentrated. The concentrate was dissolved in acetone again and to the resultant solution, an activated carbon was added, followed by stirring the resultant reaction solution. The reaction solution was filtered and the filtrate was concentrated, followed by drying a deposited solid under reduced pressure to obtain a yellow brown solid (about 50 g). The obtained solid was dissolved in hexane and to the resultant solution, ethanol was added to crystallize the resultant reaction solution, followed by filtering and drying under reduced pressure the resultant crystal, thus obtaining 2,6-dibromo-4-iodotoluene (28.4 g, yield: 43%, compound M4a) as a white crystal.

The result of the ¹H-NMR analysis of the compound M4a is illustrated below.

¹H-NMR (300 MHz, CDCl₃): δ (ppm)=2.51 (s, 3H), 7.83 (s, 2H)

(Step (4b))

In an argon gas atmosphere, in a flask, into a solution in which the compound M4a (22.6 g, 60.0 mmol) was dissolved in dehydrated tetrahydrofuran (300 mL), a tetrahydrofuran solution of isopropylmagnesium chloride (manufactured by Sigma Aldrich Corp., concentration: 2.0 M, 60 mL) was dropped at room temperature over 10 minutes and the resultant reaction solution was stirred at room temperature for 1 hour. The reaction solution was cooled down in an ice bath and thereto, 2-isopropyloxy-4,4,5,5-tetramethyl-1,3,2-dioxaborolan (22.3 g, 120 mmol) was added. The resultant reaction solution was stirred at room temperature for 2 hours and was cooled down in an ice bath again and into the reaction solution, 0.1 N hydrochloric acid (180 mL) was dropped. The resultant reaction solution was extracted with ethyl acetate and the organic phase was washed with a 15% by weight brine twice, was dried over sodium sulfate anhydride, and was filtered. The filtrate was concentrated and thereto, methanol was added to deposit a solid. The deposited solid was filtered and was dried under reduced pressure, thus obtaining 2,6-dibromo-4-(4,4,5,5-tetramethyl-1,3,2-dioxaborolan-2-yl)toluene (16.3 g, yield 72%, compound M4b) as a white crystal.

The result of the ¹H-NMR analysis of the compound M4b is illustrated below.

¹H-NMR (300 MHz, CDCl₃): δ (ppm)=1.33 (s, 12H), 2.58 (s, 3H), 7.90 (s, 2H)

(Step (4c))

In an argon gas atmosphere, in a flask, 4-bromo-tert-butylbenzene (125 g, 587 mmol) was dissolved in dehydrated tetrahydrofuran (470 mL) and the resultant reaction solution was cooled down to −70° C. Into the reaction solution, an n-butyllithium/hexane solution (1.6 M, 367 mL, 587 mmol) was dropped over 90 minutes and then, the resultant reaction solution was stirred for 2 hours to prepare a 4-tert-butylphenyllithium/tetrahydrofuran solution.

Separately, in an argon gas atmosphere, in a flask, cyanur chloride (50.8 g, 276 mmol) was dissolved in dehydrated tetrahydrofuran (463 mL) and the resultant solution was cooled down to −70° C. Thereinto, the whole amount of the thus-prepared 4-tert-butylphenyllithium/tetrahydrofuran solution was dropped at a rate by which the internal temperature of the flask maintained −60° C. or less. After the completion of dropping, the resultant reaction solution was stirred at −40° C. for 4 hour and then, at room temperature for 4 hours. To the reaction solution, ion-exchanged water (50 mL) was slowly added and then, the solvent was distilled off under reduced pressure. To the resultant residue, ion-exchanged water and chloroform were added to extract the residue into an organic phase and further, the organic phase was washed with ion-exchanged water, followed by distilling off the solvent from the organic phase under reduced pressure. To the resultant residue, acetonitrile was added and the resultant reaction solution was stirred while heating-refluxing the reaction solution, followed by filtering insoluble matters by filtration during heating the reaction solution. The filtrate was concentrated under reduced pressure and further, the concentrated filtrate was cooled down to 70° C. to deposit and filter a solid. The resultant solid was dissolved in a solvent mixture of chloroform/hexane and the resultant solution was purified by silica gel column chromatography (eluent: chloroform/hexane), followed by recrystallizing the solution in acetonitrile, thus obtaining 4,6-bis(4-tert-butylphenyl)-2-chloro-1,3,5-triazine (41.3 g, 109 mmol, yield: 39%, compound M4c) as a white crystal.

The results of the ¹H-NMR analysis and the LC-MS analysis of the compound M4c are illustrated below.

¹H-NMR (300 MHz, CDCl₃): δ (ppm)=1.39 (s, 18H), 7.56 (d, 4H), 8.54 (d, 4H)

LC/MS (APPI, positive) m/z⁺=380 [M+H]⁺

(Step (4d))

In a nitrogen gas atmosphere, in a flask, the compound M4b (7.52 g, 20.0 mmol), the compound M4c (9.12 g, 24.0 mmol), tetrakis(triphenylphosphine) palladium (0)(2.32 g, 2.0 mmol), silver carbonate (16.5 g, 60 mmol), and dehydrated tetrahydrofuran (160 mL) were mixed and while shading and heating-refluxing the resultant reaction solution, the reaction solution was stirred for 33 hours. After the completion of the reaction, the reaction solution was diluted with toluene (400 mL) and therefrom, insoluble matters were filtered off. The filtrate was concentrated and thereto, acetonitrile (200 mL) was added, followed by stirring the resultant reaction solution for 1 hour while refluxing the reaction solution. Then, the reaction solution was cooled down to room temperature and a deposited solid was filtered and was dried under reduced pressure to obtain a crude product. The crude product was purified by medium pressure silica gel chromatography (hexane/chloroform=98/2 to 70/30 (on a volume basis)) and was subjected to recrystallization in toluene-acetonitrile repeatedly for three times, thus obtaining an objective compound M-4 (2.46 g, HPLC area percentage (ultraviolet ray wavelength: 254 nm): 99.6%, yield: 21%) as a white crystal.

The result of the ¹H-NMR analysis of the compound M-4 is illustrated below.

¹H-NMR (300 MHz, THF-d₈): δ (ppm)=1.43 (s, 18H), 2.68 (s, 3H), 7.65 (d, 4H), 8.67 (d, 4H), 8.89 (s, 2H)

### Synthesis Example 4

### Synthesis of Phosphorescent Light-Emitting Compound A

### Step 1: Synthesis of Compound (A)>

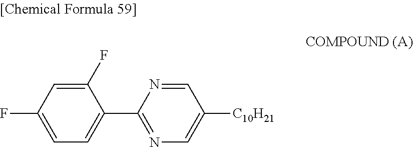

3.89 g of 2-chloro-5-n-decylpyrimidine, 2.65 g of 2,4-difluorophenylboronic acid, 35 mL of 1,2-dimethoxyethan, and 42 mL of a 2M potassium carbonate aqueous solution were charged into a two-neck flask to prepare a reaction solution. An argon gas was passed through the reaction solution for 20 minutes and to the reaction solution, 0.88 g of tetrakistriphenylphosphine palladium (0) complex was added, followed by heating and refluxing the resultant reaction solution using an oil bath in an argon atmosphere for 16 hours. The organic phase was separated and recovered and was separated and purified by silica gel chromatography (elution: solvent mixture of dichloromethane and hexane), thus obtaining 4.1 g of a compound (A).

The result of the ¹H-NMR analysis of the compound (A) is illustrated below.

¹H-NMR (400 MHz, CDCl₃): δ (ppm)=8.66 (s, 2H), 8.08-8.15 (m, 1H), 6.91-7.00 (m, 2H), 2.63 (t, 2H), 1.18-1.68 (m, 16H), 0.88 (t, 3H)

### <Step 2: Synthesis of Compound (B)>

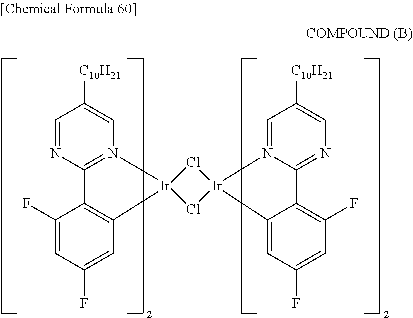

800 mg of iridium trichloride n-hydrate, 1.58 g of the compound (A), 64 mL of 2-ethoxyethanol, and 22 mL of water were charged into a two-neck flask and the resultant reaction solution was heated in an argon atmosphere for 14 hours to be refluxed. The resultant reaction solution was cooled down to room temperature and thereto, water was added, followed by filtering a generated solid, thus obtaining a compound (B). The isolation yield was 57%.

The result of the ¹H-NMR analysis of the compound (B) is illustrated below.

¹H-NMR (400 MHz, CDCl₃): δ (ppm)=9.03 (s, 4H), 8.79 (s, 4H), 6.42 (t, 4H), 5.25 (d, 4H), 2.52 (m, 4H), 2.11 (m, 4H), 1.18-1.70 (m, 64H), 0.87 (t, 12H)

### <Step 3: Synthesis of Phosphorescent Light-Emitting Compound A>

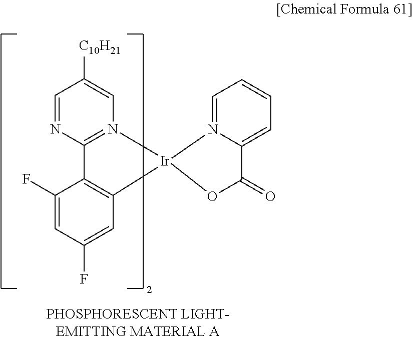

111 mg of the compound (B), 45 mg of sodium picolinate, and 40 mL of 2-ethoxyethanol were charged into an eggplant-shaped flask and the resultant reaction solution was irradiated with a microwave (2,450 MHz) in an argon atmosphere for 10 minutes. The resultant reaction solution was cooled down to room temperature and the solvent was concentrated under reduced pressure to obtain a solid. The solid was recrystallized in a solvent mixture of dichloromethane-hexane to obtain the phosphorescent light-emitting compound A. The isolation yield thereof was 74%.

The result of the ¹H-NMR analysis of the phosphorescent light-emitting compound A is illustrated below.

¹H-NMR (400 MHz, CDCl₃): δ (ppm)=8.68-8.72 (m, 3H), 8.36 (d, 1H), 8.01 (t, 1H), 7.83 (d, 1H), 7.49 (dd, 1H), 7.26 (d, 1H), 6.54 (dd, 1H), 6.47 (dd, 1H), 5.83 (d, 1H), 5.60 (d, 1H), 2.60-2.67 (m, 2H), 2.39-2.48 (m, 2H), 1.23-1.60 (m, 32H), 0.88 (t, 6H)

The phosphorescent light-emitting compound A had a light-emitting spectrum peak at 472 nm.

### Synthesis Example 5

### Synthesis of Polymer Compound P-3

In an inert gas atmosphere, the compound M-1 (0.537 g), the compound M-3 (0.227 g), the compound M-4 (0.384 g), and 15 mL of toluene were mixed and while heating the resultant reaction solution, the reaction solution was stirred. To the reaction solution, palladium (II) acetate (0.4 mg) and tris(2-methoxyphenyl)phosphine (2.3 mg) were added and the resultant reaction solution was heated to 100° C. Then, to the reaction solution, a 20% by weight tetraethylammonium hydroxide aqueous solution (5.5 mL) was added and the resultant reaction solution was refluxed for 5 hours.

Next, to the reaction solution, 2-isopropylphenylboric acid (17.9 mg), palladium (II) acetate (0.4 mg), tris(2-methoxyphenyl)phosphine (2.3 mg), and a 20% by weight tetraethylammonium hydroxide aqueous solution (3.6 mL) were added and the resultant reaction solution was refluxed further for 17 hours.

From the reaction solution, the aqueous phase was removed and to the resultant organic phase, a solution prepared by dissolving sodium N,N-diethyldithiocarbamate trihydrate (0.60 g) in ion-exchanged water (12 mL) was added, followed by stirring the organic phase at 85° C. for 2 hours. The organic phase was cooled down to room temperature and was washed with water twice, with a 3% by weight acetic acid aqueous solution twice, with water twice and the resultant toluene solution was dropped into methanol. A precipitate was deposited and then, the precipitate was filtered and dried. The thoroughly dried precipitate (solid) was purified by dissolving the precipitate in toluene and passing the resultant solution through a column filled with silica gel and alumina. The resultant toluene solution was dropped into methanol and then, a precipitate was deposited, followed by filtering and drying the precipitate. The yield of the precipitate (hereinafter, called “polymer compound P-3”) was 0.56 g. The polystyrene-equivalent number average molecular weight Mn and the polystyrene-equivalent weight average molecular weight Mw of the polymer compound P-3 measured under the above analysis conditions were Mn=2.5×10⁴ and Mw=1.1×10⁵.

From the ratios of the charged monomers, the polymer compound P-3 is estimated to be a polymer compound having the constitutional units and molar ratios below in which a constitutional unit of (PA) and a constitutional unit selected from (PB) are alternately polymerized.

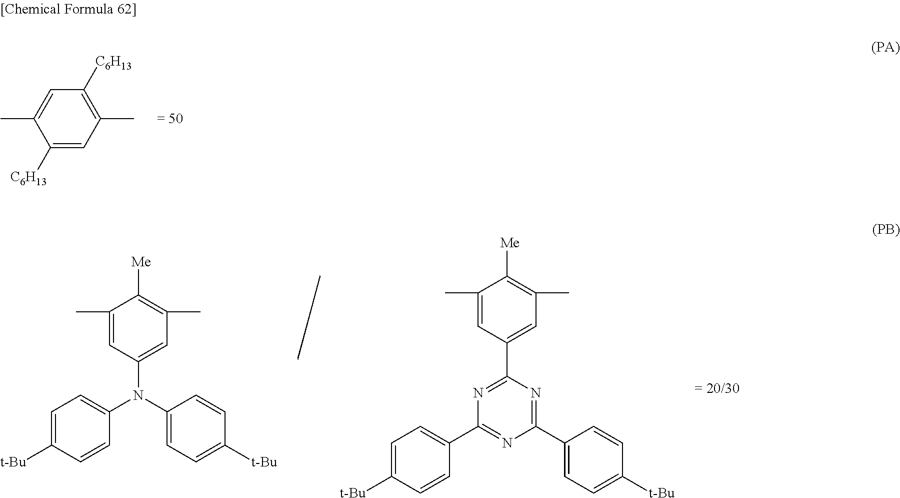

### Synthesis Example 6

### Synthesis of Light-Emitting Material T-1

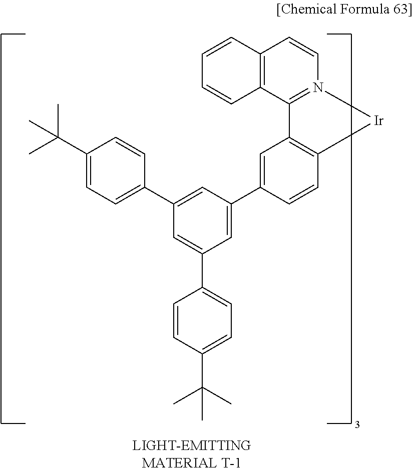

The light-emitting material T-1 was synthesized through a synthesis method described in Japanese Patent Application Laid-open No. 2006-188673.

The light-emitting material T-1 had a light-emitting spectrum peak at 619 nm.

### Synthesis Example 7

### Synthesis of Light-Emitting Material T-2

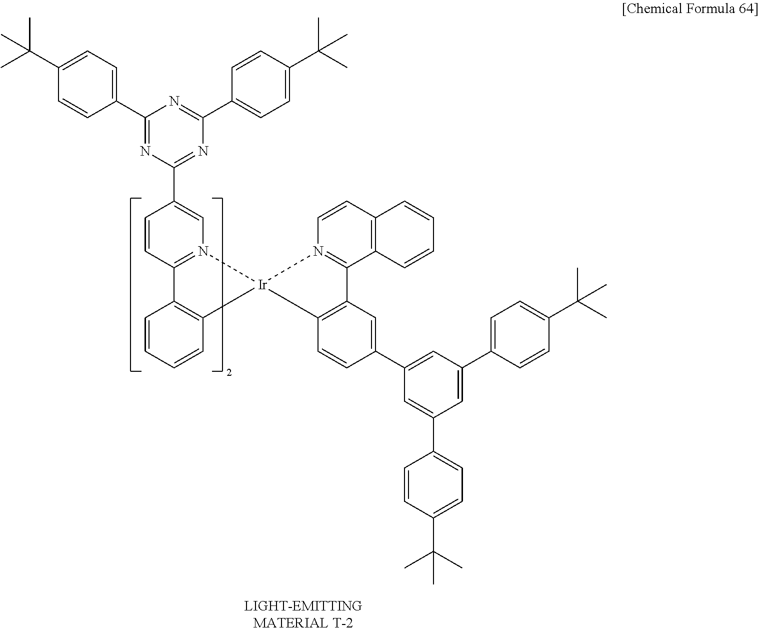

The light-emitting material T-2 was synthesized according to a synthetic method described in Japanese Patent Application Laid-open No. 2011-105701.

The light-emitting spectrum peak of the light-emitting material T-2 was at 609 nm.

### Synthesis Example 8

### Synthesis of Light-Emitting Material T-3

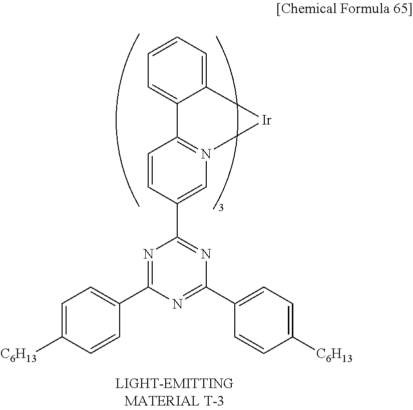

The light-emitting material T-3 was synthesized according to a synthetic method described in Japanese Patent Application Laid-open No. 2008-179617.

The light-emitting spectrum peak of the light-emitting material T-3 was at 594 nm.

### Synthesis Example 9

### Synthesis of Light-Emitting Material CT-1

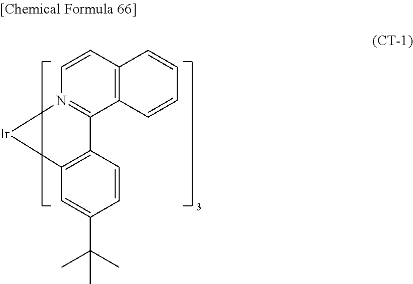

The light-emitting material CT-1 was synthesized according to a synthetic method described in International Publication No. WO 2002/44189.

The light-emitting spectrum peak of the light-emitting material CT-1 was at 617 nm.

### Synthesis Example 10

### Synthesis of Polymer Compound HP-1

In an inert atmosphere, 5.20 g of 2,7-bis(1,3,2-dioxaborolan-2-yl)-9,9-dioctylfluorene, 5.42 g of bis(4-bromophenyl)-(4-sec-butylphenyl)-amine, 2.2 mg of palladium acetate, 15.1 mg of tris(2-methylphenyl)phosphine, 0.91 g of trioctylmethylammonium chloride (trade name: Aliquat 336; manufactured by Sigma Aldrich Corp.), and 70 mL of toluene were mixed and the resultant reaction solution was heated to 105° C. Into the reaction solution, 19 mL of a 2M sodium carbonate aqueous solution was dropped and the resultant reaction solution was refluxed for 4 hours. After the completion of the reaction, 121 mg of phenylboronic acid was added to the reaction solution and further, the resultant reaction solution was refluxed for 3 hours. Next, to the reaction solution, an aqueous solution of sodium N,N-diethyldithiocarbamate trihydrate was added and the resultant reaction solution was stirred at 80° C. for 2 hours. The reaction solution was cooled down and then, the reaction solution was washed with water, a 3% by weight acetic acid aqueous solution, and water in this order, followed by passing the resultant toluene solution through an alumina column and a silica gel column to be purified. The resultant toluene solution was dropped into a large amount of methanol and the resultant reaction solution was stirred. The resultant precipitate was filtered and was dried to obtain a polymer compound HP-1. The polystyrene-equivalent number average molecular weight Mn and the polystyrene-equivalent weight average molecular weight Mw of the polymer compound HP-1 that were measured under the above-described analysis conditions, were 8.4×10⁴ and 3.4×10⁵ respectively.

It is presumed from the charging ratios of the monomers that the polymer compound HP-1 is a polymer compound having a constitutional unit below and a mole fraction below in which the constitutional units are alternately polymerized.

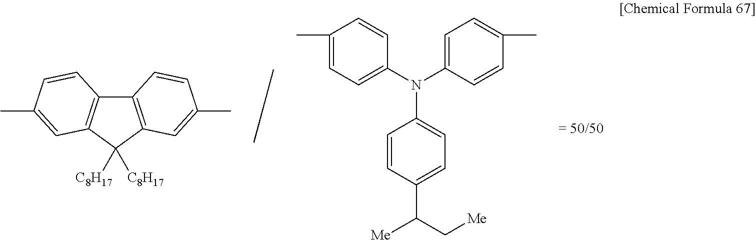

### Synthesis Example 11

### Synthesis of Light-Emitting Material U

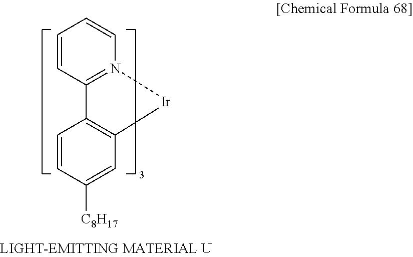

The light-emitting material U was synthesized through a synthesis method described in Journal of American Chemical Society, Vol. 107, pp. 1431-1432 (1985).

The light-emitting material U had a light-emitting spectrum peak at 508 nm.

### Example 1

### Manufacturing of Light-Emitting Device E1

(Step 1) Onto a glass substrate coated with an ITO film by a sputtering method in a thickness of 45 nm, a suspension of poly(3,4-ethylenedioxythiophene)/polystyrenesulfonic acid (manufactured by H.C. Starck GmbH; trade name: CLEVIOS P AI4083) (hereinafter, called “CLEVIOS P”) was placed and was made to a coating film by a spin coating method so as to have a thickness of about 50 nm, and the resultant coating film was dried on a hot plate at 200° C. for 10 minutes. Next, the polymer compound HP-1 was dissolved in xylene (manufactured by Kanto Chemical Co., Ltd.; for the electronic industries (EL grade)) in a concentration of 0.7% by weight, and the resultant xylene solution was placed onto the film of CLEVIOS P and was made to a coating film by a spin coating method so as to have a thickness of about 20 nm. The resultant coating film was dried in a nitrogen atmosphere having an oxygen concentration and a water concentration of each 10 ppm or less (on a weight basis) at 180° C. for 60 minutes, thus obtaining a thermally treated film.
(Step 2) Next, the polymer compound P-3, the phosphorescent light-emitting compound A, and the light-emitting materials U and T-1 were dissolved in xylene (manufactured by Kanto Chemical Co., Ltd.; for the electronic industries (EL grade)) in a concentration of 1.9% by weight of the above-described materials (in a weight ratio of polymer compound P-3/phosphorescent light-emitting compound A/light-emitting material U/light-emitting material T=77/20/2.0/1.0).
(Step 3) The resultant xylene solution resulting from Step 2 was placed onto the thermally treated film of the polymer compound HP-1 and was made to a coating film as a light-emitting layer by a spin coating method so as to have a thickness of about 60 nm. Then, in a nitrogen atmosphere having an oxygen concentration and a water concentration of each 10 ppm or less (on a weight basis), the resultant coating film was dried at 130° C. for 10 minutes. The pressure of the atmosphere was reduced to 1.0×10⁻⁴ Pa or less and as the cathode, barium was vapor-deposited on the film of the light-emitting layer in a thickness of about 5 nm and next, aluminum was vapor-deposited on the barium layer in a thickness of about 60 nm. After the vapor-deposition, the sealing was performed using a glass substrate, thus manufacturing a light-emitting device E1.

### Example 2

### Manufacturing of Light-Emitting Device E2

Example 2 was performed in the same manner as in Example 1, except that the step 2 of Example 1 was changed to “the polymer compound P-3, the phosphorescent light-emitting compound A, the light-emitting material U, and the light-emitting material T-1 were dissolved in xylene (manufactured by Kanto Chemical Co., Ltd.; for electric industry (EL grade)) in a concentration of 1.9% by weight (in a weight ratio of polymer compound P-3/phosphorescent light-emitting compound A/light-emitting material U/light-emitting material T-1=78.5/20/1/0.5)” to manufacture the light-emitting device E2.

### Example 3

### Manufacturing of Light-Emitting Device E3

Example 3 was performed in the same manner as in Example 1, except that the step 2 of Example 1 was changed to “the polymer compound P-3, the phosphorescent light-emitting compound A, the light-emitting material U, and the light-emitting material T-1 were dissolved in xylene (manufactured by Kanto Chemical Co., Ltd.; for electric industry (EL grade)) in a concentration of 1.9% by weight (in a weight ratio of polymer compound P-3/phosphorescent light-emitting compound A/light-emitting material U/light-emitting material T-1=79.25/20/0.5/0.25)” to manufacture the light-emitting device E3.

### Example 4

### Manufacturing of Light-Emitting Device E4

Example 4 was performed in the same manner as in Example 1, except that the step 2 of Example 1 was changed to “the polymer compound P-3, the phosphorescent light-emitting compound A, the light-emitting material U, and the light-emitting material T-1 were dissolved in xylene (manufactured by Kanto Chemical Co., Ltd.; for electric industry (EL grade)) in a concentration of 1.9% by weight (in a weight ratio of polymer compound P-3/phosphorescent light-emitting compound A/light-emitting material U/light-emitting material T-1=79.4/20/0.5/0.1)” to manufacture the light-emitting device E4.

### Example 5

### Manufacturing of Light-Emitting Device E5

Example 5 was performed in the same manner as in Example 1, except that the step 2 of Example 1 was changed to “the polymer compound P-3, the phosphorescent light-emitting compound A, the light-emitting material U, and the light-emitting material T-1 were dissolved in xylene (manufactured by Kanto Chemical Co., Ltd.; for electric industry (EL grade)) in a concentration of 1.9% by weight (in a weight ratio of polymer compound P-3/phosphorescent light-emitting compound A/light-emitting material U/light-emitting material T-1=79/20/0.5/0.5)” to manufacture the light-emitting device E5.

### Example 6

### Manufacturing of Light-Emitting Device E6

Example 6 was performed in the same manner as in Example 1, except that the step 2 of Example 1 was changed to “the polymer compound P-3, the phosphorescent light-emitting compound A, the light-emitting material U, and the light-emitting material T-1 were dissolved in xylene (manufactured by Kanto Chemical Co., Ltd.; for electric industry (EL grade)) in a concentration of 1.9% by weight (in a weight ratio of polymer compound P-3/phosphorescent light-emitting compound A/light-emitting material U/light-emitting material T-1=70/29.6/0.2/0.2)” to manufacture the light-emitting device E6.

### Example 7

### Manufacturing of Light-Emitting Device E7

Example 7 was performed in the same manner as in Example 1, except that the step 2 of Example 1 was changed to “the polymer compound P-3, the phosphorescent light-emitting compound A, the light-emitting material U, and the light-emitting material T-2 were dissolved in xylene (manufactured by Kanto Chemical Co., Ltd.; for electric industry (EL grade)) in a concentration of 1.9% by weight (in a weight ratio of polymer compound P-3/phosphorescent light-emitting compound A/light-emitting material U/light-emitting material T-2=70/29.6/0.2/0.2)” to manufacture the light-emitting device E7.

### Example 8

### Manufacturing of Light-Emitting Device E8

Example 8 was performed in the same manner as in Example 1, except that the step 2 of Example 1 was changed to “the polymer compound P-3, the phosphorescent light-emitting compound A, the light-emitting material U, and the light-emitting material T-3 were dissolved in xylene (manufactured by Kanto Chemical Co., Ltd.; for electric industry (EL grade)) in a concentration of 1.9% by weight (in a weight ratio of polymer compound P-3/phosphorescent light-emitting compound A/light-emitting material U/light-emitting material T-3=70/29.6/0.2/0.2)” to manufacture the light-emitting device E8.

### Example 9

### Manufacturing of Light-Emitting Device E9

Example 9 was performed in the same manner as in Example 1, except that the step 2 of Example 1 was changed to “poly(9-vinylcarbazole) (polymer compound PVK) (manufactured by Sigma Aldrich Corp.; weight average molecular weight was 1.1×10⁶ or less; powder), the phosphorescent light-emitting compound A, the light-emitting material U, and the light-emitting material T-1 were dissolved in xylene (manufactured by Kanto Chemical Co., Ltd.; for electric industry (EL grade)) in a concentration of 1.9% by weight (in a weight ratio of polymer compound PVK/phosphorescent light-emitting compound A/light-emitting material U/light-emitting material T-1=70/29.6/0.2/0.2)” to manufacture the light-emitting device E9.

### Comparative Example 1

### Manufacturing of Light-Emitting Device C1

Comparative Example 1 was performed in the same manner as in Example 1, except that the step 2 of Example 1 was changed to “the polymer compound P-3, the phosphorescent light-emitting compound A, the light-emitting material U, and the light-emitting material CT-1 were dissolved in xylene (manufactured by Kanto Chemical Co., Ltd.; for electric industry (EL grade)) in a concentration of 1.9% by weight (in a weight ratio of polymer compound P-3/phosphorescent light-emitting compound A/light-emitting material U/light-emitting material CT-1=70/29.6/0.2/0.2)” to manufacture the light-emitting device C1.

<Evaluation of Light-Emitting Device>

To the light-emitting devices E1 to E9 and C1, a voltage was applied and the external quantum efficiency (%) and the chromaticity at a brightness of 100 cd/m² were measured. The results thereof are listed in Table 8.

TABLE 8

| | | LIGHT-EMITTING LAYER | | | EXTERNAL | |
|---|---|---|---|---|---|---|
| | LIGHT | | PHOSPHORESCENT | | QUANTUM | |
| | EMITTING | POLYMER | LIGHT-EMITTING | COMPOSITION | EFFICIENCY | CHROMATICITY |
| | DEVICE | COMPOUND | COMPOUND | RATIO | (%) | CIE (X, Y) |
| EXAMPLE 1 | E1 | P-3 | A/U/T-1 | 77/20/2/1 | 9.78 | (0.48, 0.46) |
| EXAMPLE 2 | E2 | P-3 | A/U/T-1 | 78.5/20/1/0.5 | 8.14 | (0.46, 0.48) |
| EXAMPLE 3 | E3 | P-3 | A/U/T-1 | 79.25/20/0.5/0.25 | 7.96 | (0.35, 0.51) |
| EXAMPLE 4 | E4 | P-3 | A/U/T-1 | 79.4/20/0.5/0.1 | 9.42 | (0.39, 0.51) |
| EXAMPLE 5 | E5 | P-3 | A/U/T-1 | 79/20/0.5/0.5 | 8.81 | (0.31, 0.55) |
| EXAMPLE 6 | E6 | P-3 | A/U/T-1 | 70/29.6/0.2/0.2 | 7.34 | (0.31, 0.50) |
| EXAMPLE 7 | E7 | P-3 | A/U/T-2 | 70/29.6/0.2/0.2 | 7.56 | (0.34, 0.50) |
| EXAMPLE 8 | E8 | P-3 | A/U/T-3 | 70/29.6/0.2/0.2 | 7.40 | (0.38, 0.49) |
| EXAMPLE 9 | E9 | PVK | A/U/T-1 | 70/29.6/0.2/0.2 | 7.82 | (0.31, 0.48) |
| COMPARATIVE | C1 | P-3 | A/U/CT-1 | 70/29.6/0.2/0.2 | 6.81 | (0.28, 0.52) |
| EXAMPLE 1 | | | | | | |

The above descriptions are examples of the present invention and the present invention should not be limited to the examples. Although some exemplified embodiments of the present invention are described, it is considered that the person skilled in the art easily recognizes that without substantially departing from a novel instruction and advantage of the present invention, many modifications are possible in the exemplified embodiments. Therefore, all of such modifications should be encompassed in the scope of the present invention defined as the scope of claims. The present invention is defined by the scope of claims in combination with equivalents that should be encompassed in the scope of claims.

1. A composition comprising a phosphorescent light-emitting compound (B) that has a light-emitting spectrum peak smaller than 480 nm, a phosphorescent light-emitting compound (G) that has a light-emitting spectrum peak at 480 nm or larger and smaller than 580 nm, and a phosphorescent light-emitting compound (R) that has a light-emitting spectrum peak at 580 nm or larger and smaller than 680 nm, wherein
the phosphorescent light-emitting compound (R) is a phosphorescent light-emitting compound having a dendrimer structure.

2. The composition according to claim 1, wherein the phosphorescent light-emitting compound (R) is a metal complex represented by Formula (R-A):
M^{R}(L^{R1})a^{R1}(L^{R2})b^{R1} (R-A)
wherein
M^{R} represents a central metal atom;
L^{R1} represents a ligand that has a substituent having a dendrimer structure, and when L^{B1} is plurally present, L^{R1}s may be the same as or different from each other;
L^{R2} represents a ligand, with the proviso that L^{R2} is different from L^{R1}, and when L^{R2} is plurally present, L^{R2}s may be the same as or different from each other; and
a^{R1} represents an integer of 1 or more and b^{R1} represents an integer of 0 or more, with the proviso that a^{R1}+a^{R1} exists so as to satisfy a valence that the metal atom M^{R} has.

3. The composition according to claim 2, wherein M^{R} is a platinum atom or an iridium atom.

4. The composition according to claim 2, wherein L^{R1} is a monoanionic didentate ligand represented by Formula (LR): 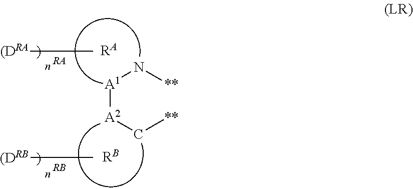
wherein
A¹ and A² each independently represent a carbon atom or a nitrogen atom;
the ring R^{A} represents a 5-membered or 6-membered aromatic heterocyclic ring having one or more nitrogen atom(s);
the ring R^{B} represents a 5-membered or 6-membered aromatic hydrocarbon ring or a 5-membered or 6-membered aromatic heterocyclic ring;
** represents a bond with the central metal atom;
D^{RA} and D^{RB} each independently represent a substituent having a dendrimer structure, and when D^{RA} and D^{RB} are plurally present, D^{RA}s or D^{RB}s are optionally the same as or different from each other; and
n^{RA} and n^{RB} each independently represent an integer of 0 or more, with the proviso that n^{RA}+n^{RB} is 1 or more.

5. The composition according to claim 4, wherein the ring R^{A} is a pyridine ring, a quinoline ring, or an isoquinoline ring.

6. The composition according to claim 4, wherein the ring R^{B} is a benzene ring.

7. The composition according to claim 1, wherein a ratio of the total weight of the phosphorescent light-emitting compound (R) and the phosphorescent light-emitting compound (G) relative to the weight of the phosphorescent light-emitting compound (B) is 0.001 or more and 0.3 or less.

8. The composition according to claim 1, wherein at least one of the phosphorescent light-emitting compound (B) and the phosphorescent light-emitting compound (G) is an iridium complex.

9. The composition according to claim 1, further comprising a host material.

10. The composition according to claim 9, wherein the host material is a polymer compound.

11. A liquid composition comprising:
the composition according to claim 1; and
a solvent.

12. A film comprising the composition according to claim 1.

13. A light-emitting device having:
an anode and a cathode; and
an organic layer comprising the composition according to claim 1 provided between the anode and the cathode.

14. The light-emitting device according to claim 13, wherein the light-emitting device emits white color light.
